(19) United States
(12) Patent Application Publication
(10) Pub. No.: US 2002/0085888 A1
(43) Pub. Date: Jul. 4, 2002

(54) Electronic supports and methods and apparatus for forming apertures in electronic supports

(76) Inventors: Vedagiri Velpari, Monroeville, PA (US); Charles B. Greenberg, Murrysville, PA (US); Bruce E. Novich, Barrington, RI (US)

Correspondence Address: PPG INDUSTRIES INC, INTELLECTUAL PROPERTY DEPT, ONE PPG PLACE, PITTSBURGH, PA, 15272, US

(21) Appl. No.: 09/783,540

(22) Filed: Feb. 15, 2001

Related U.S. Application Data
(60) Provisional application No. 60/183,979, filed on Feb. 22, 2000.
(60) Provisional application No. 60/184,026, filed on Feb. 22, 2000.
(60) Provisional application No. 60/233,619, filed on Sep. 18, 2000.
(60) Provisional application No. 60/233,619, filed on Sep. 18, 2000.

(51) Int. Cl. B23B 35/00

(52) U.S. Cl. 408/1 R; 408/56; 408/59

(57) ABSTRACT

The present invention provides a method of forming an aperture in an electronic support, comprising: (A) positioning an electronic support in registry with an aperture forming device; and (B) forming an aperture at least partially through the electronic support with the aperture forming device while dispensing a fluid stream comprising at least one solid lubricant, proximate the aperture forming device during at least a position of the forming, such that the at least one solid lubricant contacts at least a portion of an interface between the aperture forming device and the electronic support.

### REFERENCE TO PRIOR APPLICATIONS

This application claims the benefit of U.S. Provisional Application Ser. No. 60/183,979, entitled “Electronic Supports and Methods of Making the Same” filed on Feb. 22, 2000, U.S. Provisional Application Ser. No. 60/184,026 entitled “Methods and Apparatus for Forming Apertures in Electronic Supports and Electronic Supports Made Therefrom” filed on Feb. 22, 2000, and U.S. Provisional Application Ser. No. 60/233,619 entitled “Electronic Supports and Methods and Apparatus for Forming Apertures in Electronic Supports” filed on Sep. 18, 2000.

### BACKGROUND OF THE INVENTION

1. Field of the Invention

The present invention relates generally to electronic supports and methods of making electronic supports, and in particular relates to prepreg layers, laminates, clad laminates, and printed circuit boards and methods of making the same. The present invention further relates to methods and apparatus for forming apertures in electronic supports made in accordance with the present invention, and more particularly relates to mechanically drilling apertures in printed circuit boards.

2. Technical Considerations

Electronic supports, and particularly printed circuit boards (commonly referred to as PCBs or printed wiring boards (PWBs)) are typically formed from laminates comprised of two or more layers of polymer impregnated reinforcement layers, generally referred to as prepregs, and one or more electrically conductive layers laminated together by the application of heat and pressure. The production of a printed circuit board typically requires the formation of apertures (also called holes or vias) in the circuit board in order to facilitate “intraboard” electrical interconnection as well as interconnections between the printed circuit board and other electronic components attached thereto. Intraboard interconnections include, for example, connecting circuits patterned on different layers of the printed circuit board. Interconnection between the board and other electronic components include, for example, connections between the printed circuit board and integrated circuit devices mounted thereon. After aperture formation, which is typically accomplished by drilling, the walls of the holes are typically plated to form an electrically conductive pathway. The circuits are patterned on the one or more electrically conductive layers by methods well known in the art, such as photoimaging and etching.

As the electronics industry continues to increase the number of circuits and functionality that can be fabricated on a single integrated circuit device, the need for more connections on the printed circuit board, both intraboard and between the board and other components, must also increase to support the devices. Increasing the size of the circuit board to accommodate the increased number of connections is impractical given both the size and weight restrictions dictated by the final product into which the circuit board will be incorporated and the performance demands of the product. Accordingly, in order to accommodate increased connectivity requirements, the size of the features (e.g. the diameter of the holes and the width of the patterned lines) of the printed circuit board can be decreased while the number of metal layers incorporated into the circuit board can be increased.

The decreased feature size requirement and the increased layer count requirement serve to make the printed circuit board fabrication process more complex and demanding. In particular, the formation of large numbers of small apertures has been observed to significantly increase the fabrication costs of printed circuit boards. See Joan Tourné, “Using New Interconnect Technologies to Reduce Substrate Cost,” Proceedings of the European Joint Conference VI: EIPC, (1997) at pages 167-174, which are specifically incorporated by reference herein. For example, the mechanical drilling of holes having diameters less than 13 mils has been observed to have a negative effect on the yield, throughput, and cost of typical mechanical drilling processes. This is due in large part to the increased drill tool wear associated with the drilling of small holes in PCBs. Drill tool wear occurs during drilling when the drill encounters a layer of glass fibers in the PCB. Glass fiber fabrics are typically used to reinforce each layer of the PCB, providing both improved rigidity and strength to the board. However, glass fibers have an abrasive effect on the drill tools and cause them to become dull. Dull or worn tools have been found to adversely impact the drilling process by decreasing the wall quality of the drilled holes, decreasing the positional accuracy of the drilled holes, increasing fiber fracture, and increasing the occurrence of other drilling defects such as burrs, nail-heading, wicking, and via (i.e. holes) surface roughness.

Additionally, as the performance requirements of integrated circuit devices increase, the power dissipation requirement of these devices also tends to increase. This results in increased heat fluxes at the surface of the device that must be controlled in order to prevent device failure. For example, it has been estimated that failure rates increase by a factor of about two for every 10° C. (18° F.) increase in operating temperature of the device. See R. Tummala and E. Rymaszewski Eds., Microelectronics Packaging Handbook, (1989) at page 168, which is specifically incorporated by reference herein. By improving the thermal conductivity of printed circuit boards onto which such devices are placed (for example, by directly mounting the device on the PCB or by attaching a second level package containing the device to the PCB), the performance and reliability of the devices can be improved.

There remains a need for electronic supports in the form of both laminates and printed circuit boards that possess both good drilling properties and increased functionality, and alternative apparatus and methods for drilling printed circuit boards that can increase drill life, decrease drill tool wear, improve hole wall quality, reduce drilling costs, and be incorporated into existing drilling operations without the need for additional processing steps.

### SUMMARY OF THE INVENTION

The present invention provides a method of forming an aperture in an electronic support, comprising: (A) positioning an electronic support in registry with an aperture forming device; and (B) forming an aperture at least partially through the electronic support with the aperture forming device while dispensing a fluid stream comprising at least one solid lubricant, proximate the aperture forming device during at least a position of the forming, such that the at least one solid lubricant contacts at least a portion of an interface between the aperture forming device and the electronic support.

The present invention also provides a method of forming an aperture in an electronic support, comprising: (A) locating an electronic support in registry with an aperture forming device such that a first surface of the electronic support is adjacent the aperture forming device; (B) positioning a single layer comprising at least one inorganic solid lubricant along at least a portion of the first surface of the electronic support; and (C) forming an aperture through the layer and at least partially through the electronic support with the aperture forming device.

The present invention further provides a method of forming an aperture in an electronic support, comprising: (A) locating at least one electronic support in registry with an aperture forming device such that a first surface of the electronic support is adjacent the aperture forming device; (B) positioning a layer comprising at least one inorganic solid lubricant in direct contact with at least a portion of the first surface of the electronic support; and (C) forming an aperture through the layer and at least partially through the at least one electronic support with the aperture forming device.

The present invention also provides a method of forming an aperture in an electronic support, comprising: (A) locating an electronic support in registry with an aperture forming device such that a first surface of the electronic support is adjacent the aperture forming device; (B) positioning at least one layer comprising hexagonal boron nitride along a least a portion of the first surface of the electronic support; and (C) forming an aperture through the at least one layer and at least partially through the electronic support with the aperture forming device.

The present invention further provides an aperture forming device for use in forming apertures in electronic supports, comprising: (A) a drill bit external surfaces; and (B) a coating material positioned upon at least a portion of the external surfaces of the drill bit, the coating material comprising at least one solid lubricant.

The present invention provides a method of forming an aperture in an electronic support, comprising: (A) locating an electronic support in registry with an aperture forming device, the aperture forming device comprising: (1) a drill bit having external surfaces; and (2) a coating material positioned upon at least a portion of the external surfaces of the drill bit, the coating material comprising at least one lamellar solid lubricant; and (B) penetrating at least a first side of the electronic support with the drill bit to form an aperture extending at least partially through the electronic support.

The present invention also provides a method of forming an aperture in an electronic support, comprising: (A) locating an electronic support in registry with an aperture forming device such that a first surface of the electronic support is adjacent a drill bit of the aperture forming device, the drill bit comprising: (1) a channel extending at least partially through an interior portion of the drill bit, and (2) at least one hole extending from an external surface of the drill bit into the channel; (B) forming an aperture at least partially through the electronic support with the drill bit of the aperture forming device; and (C) passing at least one solid lubricant through the channel of the drill bit and out the at least one hole during at least a portion of the forming to provide lubrication.

The present invention also provides a method of forming an aperture in an electronic support, comprising: (A) locating an electronic support in registry with an aperture forming device such that a first surface of the electronic support is adjacent the aperture forming device, the electronic support comprising at least one internal lubricant layer; and (B) forming an aperture through the at least one internal lubricant layer and at least partially through the electronic support with the aperture forming device.

The present invention provides a printed circuit board comprising at least one aperture extending at least partially through the printed circuit board, wherein the aperture is formed by: (A) locating an electronic support in registry with an aperture forming device; and (B) forming an aperture at least partially through the electronic support with the aperture forming device while dispensing a fluid stream comprising at least one solid lubricant proximate the aperture forming device during at least a portion of the forming, such that the at least one solid lubricant contacts at least a portion of an interface between the aperture forming device and the electronic support.

The present invention also provides a printed circuit board comprising at least one aperture extending at least partially through the printed circuit board, wherein the aperture is formed by: (A) locating an electronic support in registry with an aperture forming device such that a first surface of the electronic support is adjacent the aperture forming device; (B) positioning a layer comprising at least one inorganic solid lubricant along at least a portion of the first surface of the electronic support; and (C) forming an aperture through the layer and at least partially through the electronic support with the aperture forming device.

The present invention further provides a printed circuit board comprising at least one aperture extending at least partially through the printed circuit board, wherein the aperture is formed by: (A) positioning an electronic support in registry with an aperture forming device, the aperture forming device comprising: (1) a drill bit having external surfaces; and (2) a coating material positioned upon at least a portion of the external surfaces of the drill bit, the coating material comprising at least one lamellar solid lubricant; and (B) penetrating the first side of the printed circuit board with the drill bit to form an aperture extending at least partially through the electronic support.

### BRIEF DESCRIPTION OF THE DRAWINGS

FIG. 1 is a cross-sectional view of one nonlimiting embodiment of an electronic support incorporating features of the present invention.

FIG. 2 is a cross-sectional view of another nonlimiting embodiment of an electronic support incorporating features of the present invention.

FIG. 3 is a cross-sectional view of another nonlimiting embodiment of an electronic support incorporating features of the present invention.

FIG. 4 is a cross-sectional view of an electronic support having an aperture formed therein and incorporating features of the present invention.

FIGS. 5-7 are cross-sectional views similar to FIG. 4 of alternate embodiments of an electronic support having an aperture formed therein and incorporating features of the present invention.

FIG. 8 is a schematic view of an aperture forming device incorporating features of the present invention.

FIG. 9 is an end view of a drill illustrating the primary cutting edge of the drill tip.

### DETAILED DESCRIPTION OF THE INVENTION

The electronic supports and methods of forming electronic supports according to the present invention are particularly advantageous in providing electronic supports in the form of laminates and printed circuit boards having good drilling properties, reduced processing costs, increased processing yields, good thermal conductivity, and increased functionality. Furthermore, the methods and apparatus of the present invention are particularly useful for forming apertures in electronic supports and, more specifically in printed circuit boards.

As used herein, the term “electronic support” means a structure that can mechanically support and/or electrically interconnect elements including, but not limited to, active electronic components, passive electronic components, printed circuits, integrated circuits, semiconductor devices and other hardware associated with such elements including, but not limited to connectors, sockets, retaining clips and heat sinks. Although not limiting in the present invention, electronic supports can include, for example, prepreg layers, laminates, clad laminates, and printed circuit boards. As used herein, the term “laminate” means an electronic support formed from a polymeric matrix material reinforced with a reinforcement material; and “clad laminate” or “panel” means a laminate having an electrically conductive material in contact with at least a portion of one or more surfaces thereof. Typically, laminates are formed from two or more prepreg layers. As used herein, the term “prepreg layer” or “prepreg” means a layer of a reinforcement material having a polymeric matrix material coated on at least a portion thereof, preferably by, but not limited to, impregnation. The terms “printed circuit board” (PCB), “electronic circuit board”, and “printed wiring board” (PWB), as used herein, mean an electronic support formed from a polymeric matrix material, which can be reinforced with a reinforcement material, and comprising one or more printed circuits and/or apertures.

Printed circuit boards are commonly fabricated by impregnating a reinforcement material, typically a glass fiber reinforcement material, with a polymeric matrix material. Glass fiber reinforcement materials commonly used to form printed circuit boards include, but are not limited to, fabric, such as wovens, nonwovens (including but not limited to unidirectional, biaxial and triaxial fabrics), knits, mats (both chopped and continuous strand mats) and multilayered fabrics (i.e. overlaying layers of fabric held together by stitching or some other material to form a three-dimensional fabric structure). In addition, coated fiber strands used as warp and weft (i.e. fill) strands of a fabric can be non-twisted (also referred to as untwisted or zero twist) or twisted prior to weaving and the fabric can include various combinations of both twisted and non-twisted warp and weft strands. However, and without limiting the present invention, the glass fiber reinforcement material is typically a woven fabric.

While the present disclosure will be discussed generally in terms of electronic supports, and in particular electronic supports in the form of prepreg layers, laminates, and printed circuit boards formed from woven glass fiber fabrics, it will be appreciated by one skilled in the art that the present invention is not limited to electronic supports formed using woven reinforcements, but can include any reinforcement material including, but not limited to, those discussed above. Furthermore, the present invention is not limited to reinforced laminates and printed circuit boards, but also encompasses electronic supports in the form of unreinforced printed circuit boards. As used herein, the term “unreinforced printed circuit boards” means printed circuit boards that do not comprise a reinforcement material. Moreover, it will be appreciated by one skilled in the art that the methods of forming apertures of the present invention are useful for forming apertures in any electronic support, and in particular in printed circuit boards, including both unreinforced printed circuit boards and printed circuit boards formed using reinforcement materials discussed earlier.

For the purposes of this specification, other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

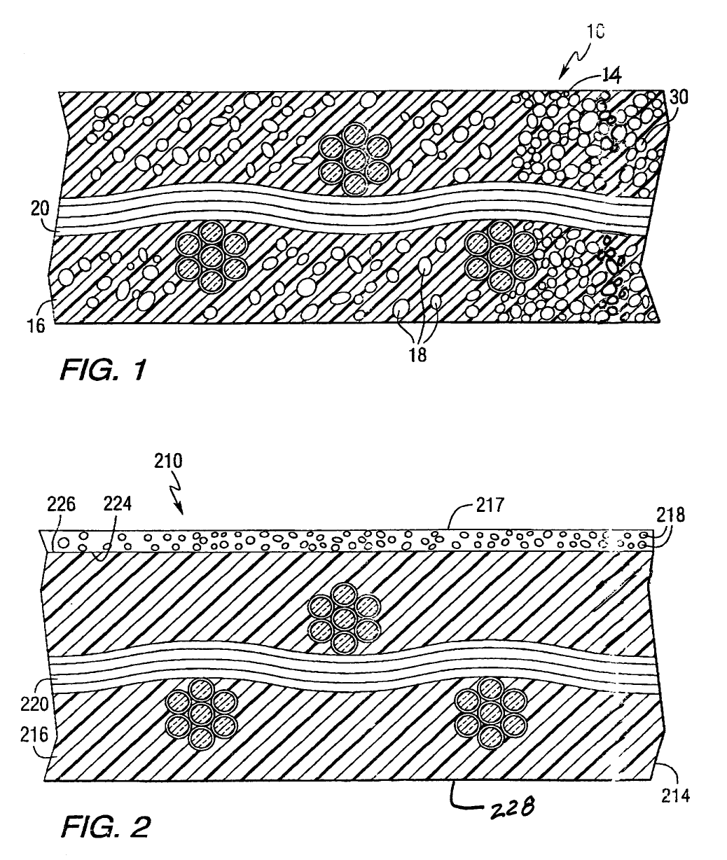

Referring to FIG. 1, there is shown an electronic support 10 according to one nonlimiting embodiment of the present invention. The electronic support 10 comprises at least one prepreg layer 14 comprising at least one woven fiber reinforcement material 20 having at least one matrix material 16 applied to at least a portion thereof. The at least one matrix material 16 comprises at least one inorganic filler 18. Although not required, in one nonlimiting embodiment of the present invention, the at least one inorganic filler 18 is a particulate inorganic filler. As used herein, the term “particulate” means discrete, non-fibrous particles. The at least one inorganic filler 18 can have any particle size and shape suitable for the desired end product. Although not limiting, in one particular embodiment of the present invention, the average particle size of the at least one inorganic filler ranges from 0.01 microns (micrometers) to 1000 microns in the major dimension. The average particle size of the particles according to the present invention can be measured according to known laser scattering techniques. In one nonlimiting embodiment of the present invention, the particles size is measured using a Beckman Coulter LS 230 laser diffraction particle size instrument, which uses a laser beam with a wave length of 750 nm to measure the size of the particles and assumes the particle has a spherical shape, i.e. the “particle size” refers to the smallest sphere that will completely enclose the particle. Examples of suitable particle shapes include, but are not limited to, cubes, faceted particles, spherical particles, platey particles, and acicular particles.

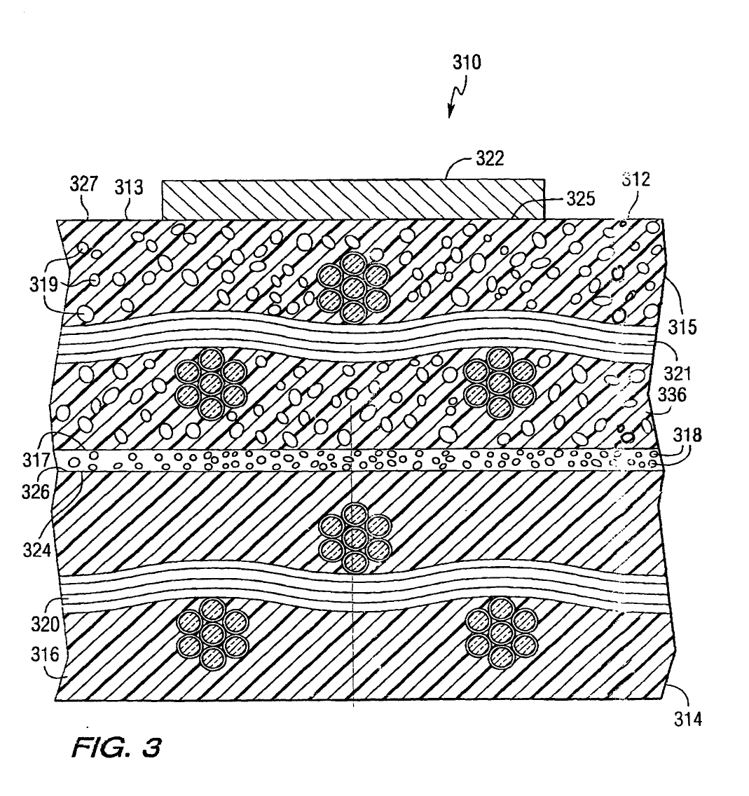

If desired, additional prepreg layers (not shown) can be secured to prepreg layer 14 to form a laminate as shown in FIG. 3, for example, by a laminating process, which will be discussed later in more detail.

Although not limiting herein, the at least one matrix material 16 of present invention will be described generally in terms of polymeric matrix materials. As used herein, the term “polymeric matrix material” means a matrix material formed from macromolecules composed of long chains of atoms that are linked together and that can become entangled in solution or in the solid state¹. However, it will be recognized by one skilled in the art that other matrix materials, such as but not limited to ceramics and glass-ceramics, can be used as the at least one matrix material in some embodiments of the present invention. Polymeric matrix materials useful in the present invention include thermosetting and thermoplastic materials. Nonlimiting examples of useful thermosetting polymeric materials include thermosetting polyesters, vinyl esters, epoxides (containing at least one epoxy or oxirane group in the molecule, such as polyglycidyl ethers of polyhydric alcohols or thiols), phenolics, aminoplasts, thermosetting polyurethanes, and derivatives and mixtures thereof. In one nonlimiting embodiment of the present invention, the polymeric matrix materials for forming laminates for printed circuit boards are FR-4 epoxy resins, which are polyfunctional epoxy resins such as difunctional brominated epoxy resins, polyimides and liquid crystalline polymers, the compositions of which are well know to those skilled in the art. If further information regarding such compositions is needed, see Electronic Materials Handbook™, ASM International (1989) at pages 534-537, which are specifically incorporated by reference herein. ¹ James Mark et al. Inorganic Polymers, Prentice Hall Polymer Science and Engineering Series, (1992) at page 1 which is hereby incorporated by reference.

Nonlimiting examples of useful thermoplastic polymeric matrix materials include polyolefins, polyamides, thermoplastic polyurethanes, thermoplastic polyesters, vinyl polymers, and mixtures thereof. Further examples of useful thermoplastic materials include polyimides, polyether sulfones, polyphenyl sulfones, polyetherketones, polyphenylene oxides, polyphenylene sulfides, polyacetals, polyvinyl chlorides, and polycarbonates.

A specific, nonlimiting example of a polymeric matrix material formulation useful in the present invention consists of EPON 1120-A80 epoxy resin (commercially available from Shell Chemical Company of Houston, Texas), dicyandiamide, 2-methylimidazole, and DOWANOL PM glycol ether (commercially available from The Dow Chemical Co. of Midland, Mich.).

Other components which can be included in prepreg layer 14 include, but are not limited to, colorants or pigments, lubricants or processing aids, ultraviolet light (UV) stabilizers, antioxidants, other fillers, such as flame retardants, and extenders.

In one nonlimiting embodiment of the present invention, the at least one matrix material 16 comprises at least one non-fluorinated polymeric material. In another nonlimiting embodiment, the at least one matrix material 16 comprises no greater than 50 weight percent fluorinated polymeric materials on a total solids basis. In another nonlimiting embodiment, the at least one matrix material 16 comprises no greater than 30 weight percent fluorinated polymeric materials on a total solids basis. In still another nonlimiting embodiment, the at least one matrix material 16 comprises no greater than 10 weight percent fluorinated polymeric materials on a total solids basis. In one nonlimiting embodiment of the invention, the at least one matrix material 16 is essentially free of fluorinated polymeric materials. As used herein, the term “essentially free of fluorinated polymeric materials” means that the polymeric matrix material comprises no greater than 5 weight percent of fluorinated polymeric materials on a total solids basis, and is preferably free of fluorinated polymeric materials. Although not meant to be limiting herein, fluorinated polymers are not preferred for use in the present embodiment as it is believed that the addition of fluorinated polymeric materials to the polymeric matrix material can increase the dielectric constant of the polymeric matrix material which, in some applications, can be detrimental to the overall performance of electronic supports made therefrom. Additionally, fluorinated polymers tend to be expensive and can increase the cost of electronic supports.

Referring to FIG. 1, inorganic fillers 18 useful in the present invention can be formed from inorganic materials such as, but not limited to, ceramic materials, such as oxides, nitrides, carbides, borides, glass materials, such as those described in detail below, metals, and other minerals, such as clay minerals. Although not limiting herein, to minimize abrasion of the reinforcement material during fabrication of the laminates, in one nonlimiting embodiment of the present invention, the at least one inorganic filler 18 has a hardness value that is no greater than a hardness value of the reinforcement material 20. The hardness values of the inorganic filler 18 and reinforcement material 20 can be determined by any conventional hardness measurement method, such as Vickers or Brinell hardness, but are preferably determined according to the original Mohs' hardness scale, which indicates the relative scratch resistance of the surface of a material. Thus, for example, if the reinforcement material is formed from glass fibers that have a Mohs' hardness value of 6, in one nonlimiting embodiment of the present invention, the Mohs' hardness value of the at least one inorganic filler is no greater than 6 and in another nonlimiting embodiment, the Mohs' hardness ranges from 0.5 to 6. The Mohs' hardness values of several nonlimiting examples of inorganic fillers suitable for use in the present invention are given in Table A below.

TABLE A

| | Mohs' Hardness |
|---|---|
| Inorganic Filler | (original scale) |
| boron nitride | 2² |
| graphite | 0.5-1³ |
| molybdenum disulfide | 1⁴ |
| talc | 1-1.5⁵ |
| mica | 2.8-3.2⁶ |
| kaolinite | 2.0-2.5⁷ |
| gypsum | 1.6-2⁸ |
| calcite (calcium carbonate) | 3⁹ |
| calcium fluoride | 4¹⁰ |
| zinc oxide | 4.5¹¹ |
| zinc sulfide | 3.5-4¹² |
| aluminum | 2.5¹³ |
| copper | 2.5-3¹⁴ |
| iron | 4-5¹⁵ |
| gold | 2.5-3¹⁶ |
| nickel | 5¹⁷ |
| palladium | 4.8¹⁸ |
| platinum | 4.3¹⁹ |
| silver | 2.5-4²⁰ |

²K. Ludema, Friction, Wear, Lubrication, (1996) at page 27, which is hereby incorporated by reference.
³R. Weast (Ed.), Handbook of Chemistry and Physics, CRC Press (1975) at page F-22.
⁴R. Lewis, Sr., Hawley's Condensed Chemical Dictionary, (12th Ed. 1993) at page 793, which is hereby incorporated by reference.
⁵R. Lewis, Sr., Hawley's Condensed Chemical Dictionary, (12th Ed. 1993) at page 1113, which is hereby incorporated by reference.
⁶R. Lewis, Sr., Hawley's Condensed Chemical Dictionary, (12th Ed. 1993) at page 784, which is hereby incorporated by reference.
⁷Handbook of Chemistry and Physics at page F-22.
⁸Handbook of Chemistry and Physics at page F-22.
⁹Friction. Wear, Lubrication at page 27.
¹⁰Friction, Wear, Lubrication at page 27.
¹¹Friction, Wear, Lubrication at page 27.
¹²Handbook of Chemistry and Physics, CRC Press (71st Ed. 1990) at page 4-158, which is hereby incorporated by reference.
¹³Friction, Wear, Lubrication at page 27.
¹⁴Handbook of Chemistry and Physics at page F-22.
¹⁵Handbook of Chemistry and Physics at page F-22.
¹⁶Handbook of Chemistry and Physics at page F-22.
¹⁷Handbook of Chemistry and Physics at page F-22.
¹⁸Handbook of Chemistry and Physics at page F-22.
¹⁹Handbook of Chemistry and Physics at page F-22.
²⁰Handbook of Chemistry and Physics at page F-22.

As mentioned above, the Mohs' hardness scale relates to the resistance of a material to scratching. The instant invention therefore contemplates inorganic fillers 18 that have a hardness at their surface that is different from the hardness of the internal portions of the filler beneath its surface. More specifically, the surface of the particle can be modified in any manner well known in the art, including but not limited to, chemically changing the particle's surface characteristics using techniques known in the art such that the surface hardness of the particle is less than or equal to the hardness of the glass fibers while the hardness of the particle beneath the surface is greater than the hardness of the glass fibers. As another alternative, a particle can be formed from a primary material that is coated, clad or encapsulated with one or more secondary materials to form a composite material that has a softer surface. Alternatively, a particle can be formed from a primary material that is coated, clad or encapsulated with a differing form of the primary material to form a composite material that has a softer surface.

In one example, and without limiting the present invention, an inorganic particle formed from an inorganic material such as silicon carbide or aluminum nitride can be provided with a silica, carbonate or nanoclay coating to form a useful composite particle. In another nonlimiting embodiment, the inorganic particles can be reacted with a coupling agent having functionality capable of covalently bonding to the inorganic particles and functionality capable of crosslinking into the film-forming material or crosslinkable resin. Such coupling agents are described in U.S. Pat. No. 5,853,809 at column 7, line 20 through column 8, line 43, which is incorporated herein by reference. Useful silane coupling agents include glycidyl, isocyanato, amino or carbamyl functional silane coupling agents. In another nonlimiting example, a silane coupling agent with alkyl side chains can be reacted with the surface of an inorganic particle formed from an inorganic oxide to provide a useful composite particle having a “softer” surface. Other examples include cladding, encapsulating or coating particles formed from non-polymeric or polymeric materials with differing non-polymeric or polymeric materials. A specific nonlimiting example of such composite particles is DUALITE, which is a synthetic polymeric particle coated with calcium carbonate that is commercially available from Pierce and Stevens Corporation of Buffalo, N.Y.

In order to minimize water absorption in the electronic supports of the present invention, in one nonlimiting embodiment of the present invention, the at least one inorganic filler 18 is non-hydratable. As used herein, “non-hydratable” means that the inorganic fillers do not react with molecules of water to form hydrates and do not contain water of hydration or water of crystallization. A “hydrate” is produced by the reaction of molecules of water with a substance in which the H—OH bond is not split. See R. Lewis, Sr., Hawley's Condensed Chemical Dictionary, (12th Ed. 1993) at pages 609-610 and T. Perros, Chemistry, (1967) at pages 186-187, which are specifically incorporated by reference herein. In the formulas of hydrates, the addition of the water molecules is conventionally indicated by a centered dot, e.g., 3MgO.4SiO₂.H₂O (talc), Al₂O₃.2SiO₂.2H₂O (kaolinite). Structurally, hydratable inorganic materials include at least one hydroxyl group within a layer of a crystal lattice (but not including hydroxyl groups in the surface planes of a unit structure or materials which absorb water on their surface planes or by capillary action), for example as shown in the structure of kaolinite given in FIG. 3.8 at page 34 of J. Mitchell, Fundamentals of Soil Behavior (1976) and as illustrated in the structure of 1:1 and 2:1 layer minerals shown in FIGS. 18 and 19, respectively, of H. van Olphen, Clay Colloid Chemistry, (2d Ed. 1977) at page 62, which are specifically incorporated by reference herein. A “layer” of a crystal lattice is a combination of sheets, which is a combination of planes of atoms. See Minerals in Soil Environments, Soil Science Society of America (1977) at pages 196-199, which is specifically incorporated by reference herein. The assemblage of a layer and interlayer material (such as cations) is referred to as a unit structure.

Hydrates contain: (1) coordinated water, which coordinates the cations in the hydrated material and cannot be removed without the breakdown of the structure; and/or (2) structural water, which occupies interstices in the structure to add to the electrostatic energy without upsetting the balance of charge. See R. Evans, An Introduction to Crystal Chemistry (1948) at page 276, which is specifically incorporated by reference herein.

In one particular nonlimiting embodiment of the present invention, the at least one inorganic filler 18 comprises no greater than 80 weight percent hydratable filler on a total solids basis. In another nonlimiting embodiment, the at least one inorganic filler 18 comprises no greater than 30 weight percent of hydratable fillers on a total solids basis. In still another nonlimiting embodiment of the present invention, the at least one inorganic filler 18 is essentially free of hydratable fillers. As used herein, the term “essentially free of hydratable fillers” means the at least one inorganic filler 18 comprises less than 5 weight percent, and more preferably less than 1 weight percent of hydratable fillers on a total solids basis.

In another nonlimiting embodiment of the present invention discussed in more detail below, the at least one inorganic filler 18 can comprise at least one filler formed from hydratable or hydrated inorganic materials in lieu of or in addition to the non-hydratable inorganic materials discussed above. Nonlimiting examples of such hydratable inorganic materials are clay minerals phyllosilicates, including micas (such as muscovite), talcs, montmorillonites, kaolinites, smectites, and gypsums.

Although not limiting in the present invention, in one embodiment the at least one inorganic filler 18 is at least one inorganic solid lubricant. As used herein, the term “inorganic solid lubricant” means solid inorganic materials that serve to reduce the friction coefficient between two surfaces and the term “solid” means a substances that does not flow perceptibly under moderate stress, has definite capacity for resisting forces which tend to deform it, and under ordinary conditions retains a definite shape and size. See Webster's 3^{rd} New International Dictionary of the English Language—Unabridged (1971) at page 2169, which is specifically incorporated by reference herein. Solid includes both crystalline and non-crystalline substances. Although not limiting in the present invention, for example, the inorganic solid lubricant can produce an anti-friction lubricating effect between a drill tool used to form apertures in an electronic support incorporating filler 18 and an adjacent solid surface of the electronic support. As used herein, the term “friction” means the resistance to sliding one solid over another. F. Clauss, Solid Lubricants and Self-Lubricating Solids, (1972) at page 1, which is specifically incorporated by reference herein.

Although not meant to be bound by any particular theory, it is believed that by incorporating prepreg layers 14 comprising at least one inorganic solid lubricant filler 18 into an electronic support 10 of the present invention, the drilling properties of the printed circuit boards formed therefrom can be improved. More particularly, it is believed that the solid lubricants can act as drilling aids (or drilling lubricants) during the drilling process, thereby reducing friction and tool wear. Furthermore, it is believed that by incorporating a solid lubricant into the laminate itself, instead of applying it externally (as in the case of an oil or other drilling lubricant), the lubricant can be available at the immediate interface between the drill tool and the electronic support, i.e. where the drill tool wear is occurring.

Although not limiting, inorganic solid lubricants as disclosed herein can have a characteristic crystalline habit which causes them to shear into thin, flat plates which readily slide over one another and thus produce an anti-friction lubricating effect between the electronic support, and more specifically the glass fiber reinforcement, and an adjacent solid surface, at least one of which is in motion. See R. Lewis, Sr., Hawley's Condensed Chemical Dictionary, (12th Ed. 1993) at page 712, which is specifically incorporated by reference herein. Although not required, in one nonlimiting embodiment of the present invention, the inorganic solid lubricant has a lamellar structure. Inorganic solid lubricants having a lamellar structure are composed of sheets or plates of atoms in hexagonal array, with strong bonding within the sheet and weak van der Waals bonding between sheets, providing low shear strength between sheets. See Friction, Wear, Lubrication at page 125, Solid Lubricants and Self-Lubricatinq Solids at pages 19-22, 42-54, 75-77, 80-81, 82, 90-102, 113-120 and 128, and W. Campbell, “Solid Lubricants”, Boundary Lubrication; An Appraisal of World Literature, ASME Research Committee on Lubrication (1969) at pages 202-203, which are specifically incorporated by reference herein.

Nonlimiting examples of suitable inorganic solid lubricants useful in the present invention having a lamellar structure include boron nitride, graphite, metal dichalcogenides, mica, talc, kaolinite, cadmium iodide, boric acid, and mixtures thereof. In one nonlimiting embodiment of the present invention, inorganic solid lubricants are selected from boron nitride, graphite, metal dichalcogenides, and mixtures thereof. Nonlimiting examples of suitable metal dichalcogenides include molybdenum disulfide, molybdenum diselenide, tantalum disulfide, tantalum diselenide, tungsten disulfide, tungsten diselenide, and mixtures thereof.

Other inorganic solid lubricants having a lamellar structure that are believed to be useful in the present invention include, but are not limited to, natural and synthetic clays that have been intercalated with organic cations. As used herein the phrase “intercalated with organic cations” means that the clay lamellae (or layers) are at least partially separated by the introduction of an organic cation into the space between adjacent layer pairs. Nonlimiting examples of intercalated clays believed to have utility in the present invention are NANOMER® nanoclays, which are commercially available from Nanocor Inc. of Arlington Heights, Ill.

In one nonlimiting embodiment of the present invention, boron nitride particles having a hexagonal crystal structure are the lamellar, solid lubricant used as an inorganic filler 18 in the present invention. Nonlimiting examples of hexagonal boron nitride particles suitable for use in the present invention are PolarTherm® 100 Series (PT 120, PT 140, PT 160 and PT 180), 300 Series (PT 350) and 600 Series (PT 620, PT 630, PT 640 and PT 670) boron nitride powder particles, which are commercially available from Advanced Ceramics Corporation of Lakewood, Ohio. See “PolarTherm™ Thermally Conductive Fillers for Polymeric Materials,” a technical bulletin of Advanced Ceramics Corporation of Lakewood, Ohio (1996), which is specifically incorporated by reference herein. These particles have a thermal conductivity of 250-300 Watts per meter Kelvin (W/mK) at 25° C. (298K), a dielectric constant of 3.9, and a volume resistivity of 10¹⁵ ohm-centimeters. The 100 Series powder particles has an average particle size ranging from 5 microns to 14 microns, the 300 Series powder particles has an average particle size ranging from 100 microns to 150 microns and the 600 Series powder particles has an average particle size ranging from 16 microns to greater than 200 microns. Without limiting the present invention, one particular grade of POLARTHERM particles useful as filler in the present invention is POLARTHERM 160 particles which, as reported by its supplier, have an average particle size of 6 to 12 micrometers, a particle size range of submicrometer to 70 micrometers, and a particle size distribution as follows:

| % > | 10 | 50 | 90 |
|---|---|---|---|
| Size (μm) | 18.4 | 7.4 | 0.6 |

According to this distribution, ten percent of the POLARTHERM 160 boron nitride particles that were measured had an average particle size greater than 18.4 micrometers. As used herein, the “average particle size” refers to the mean particle size of the particles. The average particle size of the particles according to the present invention can be measured according to known laser scattering techniques. In one nonlimiting embodiment of the present invention, the particles size is measured using a Beckman Coulter LS 230 laser diffraction particle size instrument, which as described earlier uses a laser beam with a wave length of 750 nm to measure the size of the particles and assumes the particle has a spherical shape. An independent analysis of the particle size of a sample of POLARTHERM 160 boron nitride particles measured using the Beckman Coulter LS 230 particle size analyzer found that the boron nitride particles had an average particle size of 11.9 micrometers, with particles ranging from submicrometer to 35 micrometers and having the following particle size distribution:

| % > | 10 | 50 | 90 |
|---|---|---|---|
| Size (μm) | 20.6 | 11.3 | 4.0 |

According to this distribution, ten percent of the POLARTHERM 160 boron nitride particles that were measured had an average particle size greater than 20.6 micrometers.

Other nonlimiting examples of inorganic fillers that can act as inorganic solid lubricants and are believed to be suitable for use in the present invention are inorganic fillers having a fullerene (“buckyball”) structure, and antimony oxide.

In one nonlimiting embodiment of the present invention, the at least one inorganic fillers 18 is formed from a non-hydratable, lamellar, inorganic solid lubricant.

While the reduction of friction between the drill tool and the laminate, due in part to the presence of a prepreg layer 14 comprising at least one inorganic filler 18 in the matrix material which is also an inorganic solid lubricant, will tend to decrease the generation of heat during drilling, thereby reducing the incidence of resin smear in the drilled holes, it is believed that such resin smear can be further decreased if the solid lubricant has a thermal conductivity higher than that of the polymeric matrix material 16 and the reinforcement material 20. Although not meant to be bound by any particular theory, it is believed that by employing solid lubricants having high thermal conductivity, not only will the lubricating properties reduce the frictional heat generated during drilling, but also any frictional heat that is generated will be quickly dissipated by the high thermal conductivity of the solid lubricant. In other words, the heat will be drawn away from the drilling interface, thereby reducing the interfacial temperature and prevent melting of the resin. Additionally, the use of high thermal conductivity fillers can impart improved thermal spreading properties to the final printed circuit board made therefrom, thereby improving the performance and reliability of the integrated circuit devices attached thereto, as previously discussed. As used herein the term “high thermal conductivity” means material having a thermal conductivity of at least 10 W/mK at 300K, preferably at least 20 W/mK at 300K, and more preferably at least 30 W/mK at 300K.

While one nonlimiting embodiment of the present invention uses high thermal conductivity fillers that are also solid lubricants, the use of high thermal conductivity fillers that are not necessarily solid lubricants is also contemplated in the present invention.

Nonlimiting examples of high thermal conductivity materials suitable for use as inorganic fillers in the present invention are given in Table B.

TABLE B

| | Thermal conductivity |
|---|---|
| Inorganic Filler | (W/mK at 300 K) |
| graphite | up to 2000²¹ |
| molybdenum | 138²² |
| platinum | 69²³ |
| palladium | 70²⁴ |
| aluminum | 205²⁵ |
| nickel | 92²⁶ |
| copper | 398²⁷ |
| gold | 297²⁸ |
| iron | 74.5²⁹ |
| silver | 418³⁰ |
| boron nitride | 200³¹ |
| boron phosphide | 350³² |
| aluminum phosphide | 130³³ |
| aluminum nitride | 200³⁴ |
| gallium nitride | 170³⁵ |
| gallium phosphide | 100³⁶ |
| silicon carbide | 270³⁷ |
| silicon nitride | 30³⁸ |
| beryllium oxide | 240³⁹ |
| titanium diboride | 100⁴⁰ |

²¹G. Slack, “Nonmetallic Crystals with High Thermal Conductivity, J. Phys. Chem. Solids (1973) Vol. 34, p. 322, which is hereby incorporated by reference.
²²R. Tummala (Ed.), Microelectronics Packaging Handbook, (1989) at page 174, which is hereby incorporated by reference.
²³Microelectronics Packaging Handbook at page 174.
²⁴Id. at page 37, which is hereby incorporated by reference.
²⁵Id. at page 174.
²⁶Id.
²⁷Id.
²⁸Id.
²⁹Id.
³⁰Microelectronics Packaging Handbook at page 174.
³¹G. Slack, “Nonmetallic Crystals with High Thermal Conductivity, J. Phys. Chem. Solids (1973) Vol. 34, p. 322.
³²Id. at p. 325, which is hereby incorporated by reference.
³³Id. at p. 333, which is hereby incorporated by reference
³⁴Id. at p. 329, which is hereby incorporated by reference.
³⁵Id. at p. 333.
³⁶Id. at p. 321, which is hereby incorporated by reference.
³⁷Microelectronics Packaging Handbook at page 36, which is hereby incorporated by reference.
³⁸Id.
³⁹Id. at page 905, which is hereby incorporated by reference.

In one nonlimiting embodiment of the invention, the inorganic fillers 18 have a high electrical resistivity. As used herein, the term “high electrical resistivity” means that the material has an electrical resistivity of at least 1000 microohm-centimeters (μΩ-cm). For example and without limiting the present invention, high electrical resistivity fillers can be used in conventional electronic circuit board applications to inhibit loss of electrical signals due to conduction of electrons through the fillers. For specialty applications, such as circuit boards for microwave, radio frequency interference and electromagnetic interference applications, fillers having high electrical resistivity are not required. Although not limiting in the present invention, the electrical resistivity of selected materials having a high electrical resistivity that are useful as inorganic fillers 18 in the present invention are given in Table C below.

TABLE C

| | Electrical Resistivity |
|---|---|
| Inorganic Filler | (μΩ-cm) |
| boron nitride | 1.7 × 10^{19 41} |
| aluminum nitride | greater than 10^{19 42} |
| silicon carbide | 4 × 10⁵ to 1 × 10^{6 43} |
| zinc sulfide | 2.7 × 10⁵ to 1.2 × 10^{12 44} |
| diamond | 2.7 × 10^{8 45} |
| silicon nitride | 10¹⁹ to 10^{20 46} |

In one nonlimiting embodiment of the present invention,
the at least one inorganic filler 18 is at least one solid
lubricant having a high thermal conductivity
⁴⁰ESK Engineered Ceramics, Titanium Diboride Powder Datasheet TiB₂/03/95, available from Wacker Chemicals (USA), Inc., ESK Division, Norwalk, CT.
⁴¹A. Weimer (Ed.), Carbide, Nitride and Boride Materials Synthesis and Processing, (1997) at page 654, which is hereby incorporated by reference.
⁴²A. Weimer (Ed.), Carbide, Nitride and Boride Materials Synthesis and Processing, (1997) at page 654, which is hereby incorporated by reference.
⁴³A. Weimer (Ed.), Carbide, Nitride and Boride Materials Synthesis and Processing, (1997) at page 653, which is hereby incorporated by reference.
⁴⁴Handbook of Chemistry and Physics, CRC Press (71st Ed. 1990) at pages 12-63, which is hereby incorporated by reference.
⁴⁵Handbook of Chemistry and Physics, CRC Press (71st Ed. 1990) at pages 12-63, which is hereby incorporated by reference.
⁴⁶A. Weimer (Ed.), Carbide, Nitride and Boride Materials Synthesis and Processing, (1997) at page 654, which is hereby incorporated by reference.

and a high electrical resistivity. A nonlimiting example of an inorganic filler that is a solid lubricant and has both a high thermal conductivity and a high electrical resistivity is hexagonal boron nitride.

In another nonlimiting embodiment of the present invention, the at least one inorganic filler 18 has low thermal expansion. As used herein, the term “low thermal expansion” means the material has a coefficient of thermal expansion (CTE) lower than the polymeric matrix material 16. Although not required, the material having a low coefficient of thermal expansion has a CTE lower than that of the reinforcement 20. In one nonlimiting embodiment of the present invention, the inorganic filler 18 has a CTE that is negative, i.e. the inorganic filler 18 will contract on heating. For example and although not limiting herein, in one embodiment wherein the polymeric matrix material 16 is an epoxy material having a CTE ranging from 600-800×10⁻⁷ per ° C. over a temperature range of 0° C. to 200° C., the inorganic filler 18 has a CTE of less than that of the polymeric matrix material over the same temperature range, and in particular less than 600-800×10⁻⁷/° C. over the same temperature range. In another one nonlimiting embodiment, the inorganic filler 18 has a CTE of less than 100×10⁻⁷/° C. over a temperature range of 0° C. to 200° C. In still another nonlimiting embodiment, the inorganic filler 18 has a CTE of less than 50×10⁻⁷/° C. over a temperature range of 0° C. to 200° C. Although not meant to be bound by any particular theory, it is believed that the incorporation of low thermal expansion fillers into the prepreg layer 14 can reduce the z-axis thermal expansion of electronic supports 10 made therefrom. As used herein, the term “z-axis thermal expansion” means the thermal expansion of the electronic support in a direction generally parallel to the thickness of the electronic support and generally perpendicular to the major surfaces of the electronic support. As used herein the term “major surfaces” means the surfaces of the electronic support that are generally perpendicular to the thickness of the electronic support and generally parallel to the major dimension (i.e. x-y dimension) of the reinforcement material. Reduction of the z-axis thermal expansion of electronic supports can improve reliability of printed circuit boards made therefrom by, inter alia, decreasing the mismatch between the CTEs of the polymeric matrix material and the plating on the walls of apertures formed therein. Decreasing the thermal expansion mismatch between the polymeric matrix material and the plating can reduce the incidents of cracking of the plating on the aperture walls, sometime referred to as barrel cracking, in printed circuit boards. Nonlimiting examples of low thermal expansion materials believed to be useful in the present invention include those listed in Table D below.

TABLE D

| | Coefficient of Thermal |
|---|---|
| | Expansion (CTE) |
| Inorganic Filler | (× 10⁻⁷/° C.) |
| aluminum oxide | 54 at 25° C.⁴⁷ |
| magnesium oxide | 104 at 25° C.⁴⁸ |
| titanium dioxide | 75 at 25° C.⁴⁹ |
| silicon nitride | 8 at 25° C.⁵⁰ |
| Invar⁵¹ | 2 at 25° C.⁵² |
| molybdenum | 48 at 25° C.⁵³ |
| boron | 48 at 25° C.⁵⁴ |
| boron nitride | 0.77-7.5 at 20 K-1000 K |
| | (−253° C. to 727° C.)⁵⁵ |
| silicon carbide | 26 at 0° C.-200° C.⁵⁶ |
| spodumene | 9 at 20° C.-1000° C.⁵⁷ |
| β-quartz | −3 at 25° C.⁵⁸ |
| β-eucryptite | −60 at 25° C.⁵⁹ |

Other suitable inorganic fillers 18 having a low CTE include, but
are not limited to, aluminum titanate and aluminum nitride.
⁴⁷R. Tummala (Ed.), Microelectronics Packaging Handbook, (1989) at page 637, which is hereby incorporated by reference.
⁴⁸Tummala at page 637.
⁴⁹Id.
⁵⁰Id.
⁵¹Invar is an iron-nickel alloy
⁵²Id.
⁵³Id.
⁵⁴Id.
⁵⁵Hlavac, J. The Technology of Glass & Ceramics: An Introduction, (1983) at page 232, which is hereby incorporated by reference.
⁵⁶Id. at p. 278, which is hereby incorporated by reference.
⁵⁷Hlavac, at page 232.
⁵⁸Tummala at page 637.
⁵⁹Hlavac at page 232.

In another nonlimiting embodiment of the present invention, the at least one inorganic filler 18 is a material that inhibits the formation of conductive anodic filaments (CAF) within the PCB which in turn reduces electrical shorts within the PCB resulting from the filaments. Conductive anodic filaments are electrically conductive filaments that are formed in a circuit board due to the electrochemical migration of metal ions, most commonly copper ions. Generally, these filament form along the interface between the glass fiber reinforcement and the polymeric matrix material (typically epoxy) used to form the PCB. It is believed that CAF are formed when the interface between the glass fiber reinforcement and the epoxy is compromised in some manner, such as by delamination or by hydrolysis, and the PCB is subjected to high humidity and high bias conditions. When these conditions are present, an electrochemical corrosion cell can be established between oppositely charged features. For example and although not limiting herein, CAF has been observed to occur between oppositely charged lines, holes, and between lines and holes. In general, CAF is thought to occur when water penetrates the interface between the glass reinforcement and epoxy between a positively charged feature (i.e. an anode) and a negatively charged feature (i.e. a cathode). Ions, such as free chloride ions that can be present in the epoxy itself or as a contaminant, dissolve in the water forming an electrolyte and create an electrochemical corrosion cell. Corrosion of the anode can then occur by the dissolution and transport of metal ions, and in particular copper ions from the anode, through the electrolyte, toward the cathode. As the metal ions precipitate or plate-out of solution as halide salts, the insulation resistance of the space between the anode and cathode tends to decrease and leakage of current can occur between the features. If an electrically conductive pathway, or CAF, is formed between the two features, an electrical short will occur. In other cases, a portion of the anode can become so depleted of metal that an electrical open can occur. The growth of these conductive filaments can be inhibited by trapping, binding or reacting with the metal ion in a manner that prevents the ion from forming the undesired filament. In one nonlimiting embodiment of the invention, the at least one inorganic filler 18 has a high affinity for metal ions. As used herein, the term “high affinity for metal ions” means that a filler material has a tendency to complex with metal ions, adsorb metal ions on its surfaces and/or edges, entrap or encapsulate metal ions in its lattice structure and/or undergo ion exchange. Although not meant to be limiting in the present application, the use of inorganic fillers having a high affinity for metal ions, and in particular for copper ions, is believed to be advantageous in reducing or preventing electrical shorts due to the formation of conductive anodic filaments, as discussed above. By placing an inorganic filler 18 having a high affinity for metal ions in the path of the migrating metal ions, for example by dispersing the inorganic filler 18 in the polymeric matrix material 16, the metal ions migrating through the polymeric matrix material 16 can be sequestered or trapped by the inorganic filler 18, thereby inhibiting the growth of the electrically conductive filaments and resulting electrical shorts. Accordingly, in one nonlimiting embodiment of the present invention, the matrix material 16 comprises a sufficient amount of an inorganic filler 18 having a high affinity for metal ions to prevent electrical shorts due to conductive anodic filament formation.

In one nonlimiting embodiment of the present invention, the inorganic fillers 18 having a high affinity for metal ions are clay minerals having a cation exchange capacity of at least 20 milliequivalents per 100 grams of dry filler (meq/100 g). As used herein, the term “cation exchange capacity” or “CEC” means the quantity of exchangeable cations, both adsorbed and interlayer, required to balance a layer charge deficiency in a material resulting from the isomorphorous substitution of ions in the layer structure. See D. Hillel, Fundamentals of Soil Physics, (1980) at pages 71-74, and J. Mitchell, Fundamentals of Soil Behavior, (1976) at page 32, which are specifically incorporated by reference herein. CEC, which is sometime referred to as total exchange capacity, base exchange capacity, or cation adsorption capacity, is commonly measured by techniques well known to those skilled in the art and further explanation thereof is not believed to be necessary in view of the present disclosure. If more information is required, see Rich, Removal of excess salt in CEC determinations, Soil Science, vol. 93 (1962), pp. 87-94, Rich, Ca⁺² determination for CEC determinations, Soil Science, vol. 92 (1961), pp. 226-231, and http://bluehen.ags.udel.edu/deces/prod-agric/chap9-95.htm (Jan. 31, 2001), which are specifically incorporated by reference herein.

Examples of clay minerals having a cation exchange capacity of at least meq/100 g include, but are not limited to, montmorillonites, nontronites, saponites, illites (hydrous micas), vermiculites, chlorites, sepiolites, attapulgites, bentonites, hectorites, synthetic fluoromicas (as described below) and mixtures of any of the foregoing. See Hillel at pages 44-45, which are specifically incorporated by reference herein.

In another nonlimiting embodiment of the present invention, the filler 18 having a high affinity for metal ions has a cation exchange capacity of at least 80 meq/100 g. Examples of clay minerals having a CEC of at least 80 meq/100 g include, but are not limited to, montmorillonites, nontronites, saponites, vermiculites, bentonites, hectorites, illites, synthetic fluoromicas (discussed below) and mixtures of any of the foregoing.

In another nonlimiting embodiment of the present invention, the inorganic fillers 18 having a high affinity for metal ions, and in particular copper ions, are expansible clay minerals. As used herein, the term “expansible clay” means a clay capable of swelling. Generally, expansible clay minerals can provide for cation exchange capacities of at least 80 meq/100 g due to their high surface area and exchangeable interlayer cations. Nonlimiting examples of expansible clay minerals useful in the present invention include montmorillonites, vermiculites, saponites, illites, bentonites, hectorites, expansible synthetic fluoromicas, and mixture of any of the foregoing. Generally, although not required, expansible clay minerals have a negative layer charge (X) ranging from 0.1 to 0.9, that is balanced by the presence of an exchangeable interlayer cation. Minerals having a layer charge of less than 0.1, such as kaolinite and talc, do not contain interlayer cations; whereas minerals having a charge per formula unit of greater than 0.9, such as micas, contain only non-exchangeable interlayer cations and are generally not expansible in their non-weathered form. See J. B. Dixon et al. (Eds.), Minerals in the Soil Environment, (1977) at pages 200, 221-232, and Mitchell at page 32, which specifically incorporated by reference herein.

In another nonlimiting embodiment of the present invention, the expansible clay mineral having a high affinity for metal ions, and in particular copper ions, is selected from fluorophlogopites having at least a portion of their potassium cations isomorphically replaced (or substituted) by lithium cations and fluorophlogopites having at least a portion of their potassium cations isomorphically replaced by sodium cations. Sodium fluorophlogopite is a synthetic fluoromica wherein at least a portion of the interlayer potassium cations is isomorphically replaced with sodium cations. Sodium fluorophlogopite is expansible whereas typical non-weathered micas are not expansible (as discussed above). See Kirk-Othmer Encyclopedia of Chemical Technology, Vol. 13 (2^{nd} Ed., 1967) at pages 412-413, which are specifically incorporated by reference herein.

In still another nonlimiting embodiment of the present invention, the inorganic filler 18 can be any of the inorganic fillers discussed above that has been surface treated or coated with a material having a high affinity for metal ions. For example, although not limiting herein, a boron nitride particle can be treated with an organic metal ion complexing agent to form a inorganic filler having a surface having a high affinity for metal ions. Nonlimiting examples of suitable organic metal ion complexing agents include porphyrins and amines, such as ethylenediamine, triethylenetetramine, ethylenediamine-tetraacetic acid (EDTA), polyvinylpyridine, and 2-aminopyrimidine. As used herein the term “porphyrins” means complex compounds originating in living materials and having a basic structure consisting of four interconnected rings, each ring containing four carbon atoms and one nitrogen atom. Nonlimiting examples of porphyrins include red hemoglobin and green chlorophyll. See J. Hunt, Petroleum Geochemistry and Geology, (1979) at page 551, and G. Hawley, Hawley's Condensed Chemical Dictionary, (10^{th} Ed. 1981) at page 843, which are specifically incorporated by reference herein. In another nonlimiting example, a inorganic filler particle, such as boron nitride and aluminum nitride, can be coated with nanoclay particles having a cation exchange capacity of at least 20 meq/100 g to form a filler particle having a surface having a high affinity for metal ions.

In addition to the clay materials discussed above, other silicate materials that have a high affinity for metal ions, and in particular copper ions, can be used as a filler 18. For example and without limiting the present invention, porous silicates and in particular organofunctional porous silicates can be used as filler. In one nonlimiting embodiment of the present invention, the porous silicates having a high affinity for metal ions have a CEC of at least 20 meq/100 g. In another nonlimiting embodiment, the porous silicates having a high affinity for metal ions have a CEC of at least 80 meq/100 g.

In another nonlimiting embodiment of the present invention, the filler 18 having a high affinity for metal ions is characterized in terms of its capacity to remove, i.e. uptake, cations from an aqueous solution. This capacity is quantified in terms of a distribution coefficient K_{d}, which is defined as the ratio of the amount of cation sorbed per gram of solid to the amount of cation remaining per milliliter of solution and is expressed in terms of ml/g. It is expected that materials that will remove selected metal ions from an aqueous solution, and in particular remove copper ions, will also reduce CAF when incorporated into a matrix as discussed herein. Distribution coefficient K_{d} can be measured according to a method developed by Komarneni et al. at the Material Research Laboratory, The Pennsylvania State University, University Park, Pa. For more information concerning K_{d}, see Sridhar, Komarneni, Naofumi Kozai and Rustum Roy, “Novel function for anionic clays: selective transition metal cation uptake by diadochy,” Journal of Material Chemistry, 8(6) (1998), pp. 1329-1331; Sridhar Komarneni, William J. Paulus and Rustum Roy, “Novel swelling mica: synthesis, characterization and cation exchange,” New Developments in Ion Exchange: Materials, Fundamentals and Applications, Proceedings of the International Conference on Ion Exchange, Tokyo (1991), pp. 51-56; Masamichi Tsuji and Sridhar Komarneni, “An extended method for analytical evaluation of distribution coefficients on selective inorganic ion exchangers,” Separation Science and Technology, 27(6) (1992), pp. 813-821; and Masamichi Tsuji and Sridhar Komarneni, “elective exchange of divalent transition metal ions in cryptomelane-type manganic acid with tunnel structure,” Journal of Materials Research, 8(3) (1993), pp. 611-616.

To determine K_{d} using the method developed by Komarneni, a 0.5N NaCl aqueous solution containing 0.0001 N M⁺ is prepared at room temperature, where M⁺ is the cation being studied. A sample of the solution is sealed in a glass vial for 24 hours and then analyzed using techniques well know in the art, for example the direct current plasma method, to determine the exact amount of M⁺ in parts per million (ppm) in the solution. This analysis provides a reference point in determining how much M⁺ is removed during testing. A 20 mg sample of the material to be tested is equilibrated for 24 hours in a sealed glass vial with 25 ml of the solution. After equilibration, the solid and solution phases are separated and the solution is analyzed to determine the uptake of M⁺ and is reported as K_{d} (M⁺).

In one nonlimiting embodiment of the present invention, wherein the cation is Cu²⁺, the filler having a high affinity for metal ions are clay minerals or other silicates that have a K_{d} (Cu²⁺) of at least 600 ml/g. In another nonlimiting embodiment of the present invention, the particles having a high affinity for metal ions are clay minerals or other silicates that have a K_{d} (Cu²⁺) of at least 1500 ml/g. In still another nonlimiting embodiment of the present invention, the particles having a high affinity for metal ions are clay minerals or other silicates that have a K_{d} (Cu²⁺) of at least 15,000 ml/g. In another nonlimiting embodiment of the present invention, the particles having a high affinity for metal ions are clay minerals or other silicates that have a K_{d} (Cu²⁺) of at least 40,000 ml/g.

Non-liming examples of clay minerals and other silicates having an acceptable K_{d} (Cu²⁺) value include bentonites, hectorites and porous silicates, and in particular porous organofunctional silicates.

In addition to the materials discussed above re: reduction of CAF, it is believed that other chelating agents and polymers can be used as filler material having a high affinity for metal ions to reduce CAF. Although not limiting in the present invention, it is preferred that the chelating materials comprise nitrogen atom(s) containing organic functional groups, such as but not limited to amines and imines. Other nonlimiting chelating agents or polymers that could serve this purpose can have sulfur containing, oxygen containing, phosphorus containing organic functional groups or a combination of these chelating functional groups. Nonlimiting examples of additional chelating agent that can be used to reduce CAF include SILQUEST A1387 silane, which is a silylated polyazamide commercially available from Crompton Corporation of Greenwich, Conn.; and Emery 6717, a partially amidated polyethylene imine, and Versamid 140, a polyamide, both commercially available from Cognis Corporation of Cincinnati, Ohio.

Referring again to FIG. 1, the type and amount of the inorganic filler 18 incorporated into the prepreg layer 14 will depend in part upon the desired function of the inorganic filler. In one nonlimiting embodiment of the invention, the inorganic filler 18 is present in a sufficient amount to form an essentially continuous or interconnected phase 30 (see FIG. 1) through the PCB. Although not limiting in the present invention, the volume fraction of inorganic filler 18 present in the polymeric matrix material 16 can be at or above the percolation threshold (or limit) of the filler 18. As used herein, the term “percolation threshold” means the volume fraction of a filler required to form an essentially interconnected pathway of filler through the matrix material. See Tummala (1989) at pages 576-577, which are specifically incorporated by reference herein. In another nonlimiting embodiment, the filler 18 can be present as an essentially continuous layer in the electronic support (as discussed below in more detail).

Nevertheless, it will be appreciated by one skilled in the art that polymeric matrix materials 16 comprising a volume fraction of filler 18 that is less than the percolation threshold of the filler can be effective in providing the desired characteristic to electronic supports made therefrom, such as but not limited to thermal conductivity, electrical resistivity, CAF resistance, lubricity and CTE. Furthermore, since the addition of large amounts of inorganic fillers to polymeric matrix materials can be difficult, in one nonlimiting embodiment of the present invention, the polymeric matrix material comprises an amount of inorganic filler material no greater then the percolation threshold of the filler. It will also be appreciated by one skilled in the art that for a given volume fraction (or percent) of inorganic filler employed, the actual weight percent of the inorganic filler will depend upon the densities of the particulate inorganic filler and the polymeric matrix material.

Although not limiting herein, in one embodiment of the present invention, wherein the at least one inorganic filler 18 is an inorganic solid lubricant, the amount of the at least one inorganic filler 18 ranges from 0.03 weight percent to 70 weight percent of the total combined weight of the polymeric matrix material 16 and the at least one inorganic filler 18 on a total solids basis. In another nonlimiting embodiment, the amount of the at least one inorganic filler 18 ranges from 0.03 weight percent to 50 weight percent of the total combined weight of the polymeric matrix material 16 and the at least one inorganic filler 18 on a total solids basis. In still another nonlimiting embodiment, the amount of the at least one inorganic filler 18 ranges from 0.03 weight percent to 35 weight percent of the total combined weight of the polymeric matrix material 16 and the at least one inorganic filler 18 on a total solids basis.

In one nonlimiting embodiment of the present invention, wherein the at least one inorganic filler 18 has a thermal conductivity of at least 30 W/mK at 300K, the amount of the at least one inorganic filler 18 ranges from 0.3 weight percent to 70 weight percent of the total combined weight of the polymeric matrix material 16 and the at least one inorganic filler 18 on a total solids basis. In another nonlimiting embodiment, the amount of the at least one inorganic filler 18 ranges from 10 weight percent to 70 weight percent of the total combined weight of the polymeric matrix material 16 and the at least one inorganic filler 18 on a total solids basis. In still another nonlimiting embodiment, the amount of the at least one inorganic filler 18 ranges from 35 weight percent to 70 weight percent of the total combined weight of the polymeric matrix material 16 and the at least one inorganic filler 18 on a total solids basis.

In one nonlimiting embodiment of the present invention, wherein the at least one inorganic filler 18 has a low coefficient of thermal expansion, the amount of the at least one inorganic filler 18 ranges from 5 weight percent to 80 weight percent of the total combined weight of the polymeric matrix material 16 and the at least one inorganic filler 18 on a total solids basis. In another nonlimiting embodiment, the amount of the at least one inorganic filler 18 ranges from 20 weight percent to 75 weight percent of the total combined weight of the polymeric matrix material 16 and the at least one inorganic filler 18 on a total solids basis. In still another nonlimiting embodiment, the amount of the at least one inorganic filler 18 ranges from 25 weight percent to 60 weight percent of the total combined weight of the polymeric matrix material 16 and the at least one inorganic filler 18 on a total solids basis.

In one nonlimiting embodiment of the present invention, wherein the at least one inorganic filler 18 has a high affinity for metal ions, the amount of the at least one inorganic filler 18 ranges from 0.03 weight percent to 80 weight percent of the total combined weight of the polymeric matrix material 16 and the at least one inorganic filler 18 on a total solids basis. In another nonlimiting embodiment, the amount of the at least one inorganic filler 18 ranges from 10 weight to 80 weight percent of the total combined weight of the polymeric matrix material 16 and the at least one inorganic filler 18 on a total solids basis. In still another nonlimiting embodiment, the amount of the at least one inorganic filler 18 ranges from 35 weight percent to 80 weight percent of the total combined weight of the polymeric matrix material 16 and the at least one inorganic filler 18 on a total solids basis.

Referring again to FIG. 1, as discussed above, the reinforcement material 20 can be present, for example, in the form of woven and non-woven fabrics, mats, knits and mutilayered fabrics, as discussed earlier. Although not limiting in the present invention, in one embodiment the reinforcement material 20 is a woven fabric. In another nonlimiting embodiment, the reinforcement material 20 is a woven fabric comprising glass fibers, as depicted in FIG. 1.

Glass fibers useful in the present invention include, but are not limited to, those prepared from fiberizable glass compositions such as “E-glass”, “A-glass”, “C-glass”, “D-glass”, “R-glass”, “S-glass”, and E-glass derivatives. As used herein, the term “fiberizable” means a material capable of being formed into a generally continuous fibers, strands or yarns. As used herein, the term “strand” means a plurality of individual fibers; the term “fiber” means an individual filament; and the term “yarn” means a twisted strand. As used herein “E-glass derivatives” means glass compositions that include minor amounts of fluorine and/or boron and preferably are fluorine-free and/or boron-free. Furthermore, as used herein, “minor amounts of fluorine” means less than 0.5 weight percent fluorine, preferably less than 0.1 weight percent fluorine, and “minor amounts of boron” means less than 5 weight percent boron, preferably less than 2 weight percent boron. In one nonlimiting embodiment of the present invention, the glass fibers are formed from E-glass or E-glass derivatives. Such compositions and methods of making glass filaments therefrom are well known to those skilled in the art and further discussion thereof is not believed to be necessary in view of the present disclosure. If additional information is needed, glass compositions and fiberization methods are disclosed in K. Loewenstein, The Manufacturing Technology Continuous of Glass Fibres, (3d Ed. 1993) at pages 30-44, 47-60, 115-122 and 126-135; and U.S. Pat. Nos. 4,542,106 and 5,789,329, which are specifically incorporated by reference herein.

Although not limiting in the present invention, while the reinforcement material 20 can comprise at least one glass fiber, and in one nonlimiting embodiment is a woven glass fiber fabric, the reinforcement material 20 can be formed from any type of fiberizable material known to those skilled in the art including, but not limited to, fiberizable non-glass inorganic materials, fiberizable organic materials and mixtures and combinations thereof. The inorganic and organic materials can be either man-made or naturally occurring materials. One skilled in the art will appreciate that the fiberizable inorganic and organic materials can also be polymeric materials. Examples of non-glass inorganic fibers suitable for use in the present invention include, but are not limited to, ceramic fibers formed from silicon carbide, carbon, graphite, mullite, aluminum oxide, and piezoelectric ceramic materials. Nonlimiting examples of suitable animal and vegetable-derived natural fibers include cotton, cellulose, natural rubber, flax, ramie, hemp, sisal, and wool. Suitable polymeric fibers include, but are not limited to, those formed from polyamides (such as nylon and aramids), thermoplastic polyesters (such as polyethylene terephthalate and polybutylene terephthalate), acrylics (such as polyacrylonitriles), polyolefins, polyurethanes, and vinyl polymers (such as polyvinyl alcohol). Non-glass fibers believed to be useful in the present invention are discussed at length in the Encyclopedia of Polymer Science and Technology, Vol. 6 (1967) at pages 505-712, which is specifically incorporated by reference herein. It is understood that blends or copolymers of any of the above materials and combinations of fibers formed from any of the above materials can be used in the present invention, if desired.

As discussed above, while a variety of glass compositions can be used to form the reinforcements of the present invention, in one nonlimiting embodiment of the present invention, the glass reinforcement comprises at least one glass fiber having an iron content no greater than 11 weight percent of the total weight of the glass composition. In another nonlimiting embodiment, the glass reinforcement comprises at least one glass fiber having an iron content no greater than 5 weight percent of the total weight of the glass composition. Glass fibers having an iron content greater than 11 weight percent, such as but not limited to basalt fibers which typically have an FeO content of 11 weight percent and an Fe₂O₃ content of 2 weight percent based on the total glass composition, are not used in some applications due to their dark color. As used herein the term “basalt fibers” means fibers formed from igneous rock that is low in silica content, dark in color, and comparatively rich in iron and magnesium. See F. Wallenberger et al. (Ed.), Advanced Inorganic Fibers, Processes-Structures-Properties-Applications, (2000), at page 335, which is specifically incorporated by reference herein. Thus, in one nonlimiting embodiment of the present invention, the woven fiber reinforcement material is formed from at least one fiber free of basalt fibers. For specific, nonlimiting examples of basalt compositions, see R. V. Subramanian, “Basalt Fibers”, Handbook of Reinforcements for Plastics, J. Milewski and H. Katz eds. (1987), at pages 287-295, which are specifically incorporated by reference herein. In another nonlimiting embodiment of the present invention, the woven fiber reinforcement is essentially free of basalt fibers. As used herein the term “essentially free of basalt fibers” means that the woven fiber reinforcement comprises no greater than 1 weight percent basalt fibers based on a total weight of the woven fiber reinforcement, and more preferably includes no basalt fibers.

In another nonlimiting embodiment of the present invention, preferably the woven fiber reinforcement comprises at least one E-glass fiber (discussed above).

The following discussion briefly describes a method of forming glass fibers suitable for use in the present invention and is meant only to be illustrative of one possible method of forming glass fibers that can be used in accordance with the present invention and is not meant to limit the present invention in any way. In typical glass fiber forming operations, molten glass is attenuated though a plurality of apertures in a bottom wall of a bushing or spinner to form a plurality of fibers. Almost immediately after formation, the fibers are coated with a sizing composition to protect their surfaces from abrasion and to provide the fibers with necessary process characteristics. As used herein, the terms “size” or “sizing” refer to any coating composition applied to the fibers after formation. The fibers are then gathered into strands and wound onto a package for further processing. Such methods of forming glass fibers are well known in the art and additional disclosure of such methods is not believed to be necessary in view of the present invention. However, if more information on fiber forming operations is desired, see Loewenstein at pages 115-235, which are specifically incorporated by reference herein.

Sizing compositions typically applied to glass fibers to be used in the formation of woven glass fabrics are disclosed in Loewenstein at pages 238-244, which are specifically incorporated by reference herein. In addition, to protect the warp yarn in a weaving operation from abrasion as fill yarn is inserted between the warp yarns, a slashing composition is typically applied to the sized glass fiber during warping or beaming. Such slashing compositions typically include components such as polyvinyl alcohol and are well known to those skilled in the art. While such sizing and slashing compositions are generally effective in providing for good weavability of the glass fiber strands and yarns made therefrom, they are typically not compatible with the polymeric matrix materials used to form electronic supports. Accordingly, it is common practice in the industry to remove such non-resin compatible compositions from the surface of the glass fibers prior to their incorporation into a polymeric matrix material by subjecting fiber glass fabrics formed therefrom to elevated temperatures, e.g. heating the fabric at 380° C. for 60-80 hours, and/or by scrubbing the fabric. These types of operations are typically referred to as heat-cleaning, de-oiling, or de-greasing, and are hereinafter collectively referred to as “de-greasing”. Thereafter, the fabrics are re-coated with a finishing sizing. Finishing sizes typically comprise silane coupling agents and water and are applied to the fabrics to improve the compatibility between the fabric and the polymeric matrix material into which the fabric will be incorporated. However, sizing removal processes can be both damaging to the fabric and costly. Therefore, in one nonlimiting embodiment of the present invention, the reinforcement material 20 comprises a non-degreased, woven glass fiber reinforcement material, which comprises glass fibers coated with a resin compatible sizing composition. As used herein, the terms “resin compatible” or “compatible with a polymeric matrix material” mean the coating composition applied to the glass fibers is compatible with the polymeric matrix material into which the glass fibers will be incorporated such that the coating composition (or selected coating components) achieves at least one of the following properties: does not require removal prior to incorporation into the matrix material (such as by de-greasing or de-oiling), facilitates good penetration of the matrix material through the individual bundles of fibers in a mat or fabric incorporating the yarn and good penetration of the matrix material through the mat or fabric during conventional processing, and results in final products having desired physical properties and hydrolytic stability. The resin compatible sizing composition can be applied to the glass fibers either immediately after forming or sometime thereafter, e.g. after weaving. As used herein, a “non-degreased” material or fabric is one that has not undergone a conventional processing to remove non-resin compatible sizing constituents from the material or fabric.

Without limiting the present invention, one embodiment of the resin compatible sizing composition comprises one or more, and preferably a plurality of particles that when applied to the fibers adhere to the fibers and provide one or more interstitial spaces between adjacent glass fibers. Nonlimiting examples of particles include hexagonal boron nitride and hollow styrene acrylic polymeric particles.

In addition to the particles, a nonlimiting embodiment of the resin compatible sizing composition preferably comprises one or more film-forming materials, such as organic, inorganic and polymeric materials. Nonlimiting examples of film-forming materials include vinyl polymer, such as, but are not limited to, polyvinyl pyrrolidones, polyesters, polyamides, polyurethanes, and combinations thereof.

In addition to or in lieu of the film forming materials discussed above, a nonlimiting embodiment of the resin compatible sizing compositions can include one or more glass fiber coupling agents such as organo-silane coupling agents, transition metal coupling agents, phosphonate coupling agents, aluminum coupling agents, amino-containing Werner coupling agents and mixtures thereof.

A nonlimiting embodiment of the resin compatible sizing compositions can further comprise one or more softening agents or surfactants. Nonlimiting examples of softening agents include amine salts of fatty acids, alkyl imidazoline derivatives, acid solubilized fatty acid amides, condensates of a fatty acid and polyethylene imine and amide substituted polyethylene imines.

A nonlimiting embodiment of the resin compatible sizing compositions can further include one or more lubricious materials that are chemically different from the polymeric materials and softening agents discussed above to impart desirable processing characteristics to the fiber strands during weaving. Nonlimiting examples of such fatty acid esters useful in the present invention include cetyl palmitate, cetyl myristate, cetyl laurate, octadecyl laurate, octadecyl myristate, octadecyl palmitate and octadecyl stearate. Other useful fatty acid ester, lubricious materials include trimethylolpropane tripelargonate, natural spermaceti and triglyceride oils, such as but not limited to soybean oil, linseed oil, epoxidized soybean oil, and epoxidized linseed oil. The lubricious materials can also include non-polar petroleum waxes and water-soluble polymeric materials, such as but not limited to polyalkylene polyols and polyoxyalkylene polyols.

A nonlimiting embodiment of the resin compatible sizing compositions can additionally include a resin reactive diluent to further improve lubrication of the coated fiber strands. As used herein, “resin reactive diluent” means that the diluent includes functional groups that are capable of chemically reacting with the same resin with which the coating composition is compatible. The diluent can be any lubricant with one or more functional groups that react with a resin system, preferably functional groups that react with an epoxy resin system. Nonlimiting examples of suitable lubricants include lubricants with amine groups (e.g. a modified polyethylene amine), alcohol groups (e.g. polyethylene glycol), anhydride groups, acid groups (e.g. fatty acids)or epoxy groups (e.g. epoxidized soybean oil and epoxidized linseed oil).

A nonlimiting embodiment of the resin compatible sizing compositions can additionally include one or more emulsifying agents for emulsifying or dispersing components of the coating compositions, such as the particles and/or lubricious materials. Nonlimiting examples of suitable emulsifying agents or surfactants include polyoxyalkylene block copolymers, ethoxylated alkyl phenols, polyoxyethylene octylphenyl glycol ethers, ethylene oxide derivatives of sorbitol esters, polyoxyethylated vegetable oils, ethoxylated alkylphenols, and nonylphenol surfactants.

Other additives can be included in nonlimiting embodiments of the resin compatible sizing compositions, such as cross-linking materials, plasticizers, silicones, fungicides, bactericides and anti-foaming materials. Organic and/or inorganic acids or bases in an amount sufficient to provide the coating composition with a pH of 2 to 10 can also be included in the resin compatible sizing composition.

Nonlimiting examples of resin compatible sizing compositions are shown in Table E, wherein the tabled values are the weight percent of the specified component of the total coating composition on a total solids basis.

TABLE E

| | Examples | | | | | | | |
|---|---|---|---|---|---|---|---|---|
| COMPONENT | A | B | C | D | E | F | G | H |
| PVP K-30⁶⁰ | 13.7 | 13.4 | 13.5 | 13.4 | | | 15.3 | 14.2 |
| STEPANTEX 653⁶¹ | 27.9 | 27.3 | | | | | 13.6 | 12.6 |
| A-187⁶² | 1.7 | 1.6 | 1.9 | 1.9 | 2.8 | 2.3 | 1.9 | 1.7 |
| A-174⁶³ | 3.4 | 3.3 | 3.8 | 3.8 | 4.8 | 4.8 | 3.8 | 3.5 |
| EMERY 6717⁶⁴ | 2.3 | 2.2 | 1.9 | 1.9 | | | 2.5 | 2.4 |
| MACOL OP-10⁶⁵ | 1.5 | 1.5 | | | | | 1.7 | 1.6 |
| TMAZ-81⁶⁶ | 3.0 | 3.0 | | | | | 3.4 | 3.1 |
| MAZU DF-136⁶⁷ | 0.2 | 0.2 | | | | | 0.3 | 0.2 |
| ROPAQUE OP-96⁶⁸ | 39.3 | 38.6 | | | | | 43.9 | 40.7 |
| RELEASECOAT-CONC 25⁶⁹ | 4.2 | 6.3 | 6.4 | 3.8 | | | | 4.5 |
| POLARTHERMPT 160⁷⁰ | 2.7 | 2.6 | 2.6 | 5.9 | | | | 2.8 |
| SAG 10⁷¹ | | | 0.2 | 0.2 | | | | |
| RD-847A⁷² | | | 23.2 | 23.0 | | | | |
| DESMOPHEN 2000⁷³ | | | 31.2 | 31.0 | 44.4 | 44.1 | | |
| PLURONIC F-108⁷⁴ | | | 8.5 | 8.4 | | 10.9 | | |
| ALKAMULS EL-719⁷⁵ | | | 3.4 | 2.5 | | | | |
| ICONOL NP-6⁷⁶ | | | 3.4 | 4.2 | | 3.6 | | |
| POLYOX WSR 301⁷⁷ | | | | | 0.6 | 0.6 | | |
| DYNAKOLL Si 100⁷⁸ | | | | | 29.1 | 28.9 | | |
| SERMUL EN 668⁷⁹ | | | | | 2.9 | | | |
| SYNPERONIC F-108⁸⁰ | | | | | 10.9 | | | |
| EUREDUR 140⁸¹ | | | | | 4.9 | | | |
| VERSAMID 140⁸² | | | | | | 4.8 | | |
| FLEXOL EPO⁸³ | | | | | | | 13.6 | 12.6 |

⁶⁰PVP K-30 polyvinyl pyrrolidone which is commercially available from ISP Chemicals of Wayne, New Jersey.
⁶¹STEPANTEX 653 which is commercially available from Stepan Company of Maywood, New Jersey.
⁶²A-187 gamma-glycidoxypropyltrimethoxysilane which is commercially available from Crompton Corporation of Greenwich, CT.
⁶³A-174 gamma-methacryloxypropyltrimethoxysilane which is commercially available from Crompton Corporation of Greenwich, CT.
⁶⁴EMERY ® 6717 partially amidated polyethylene imine which is commercially available from Cognis Corporation of Cincinnati, Ohio.
⁶⁵MACOL OP-10 ethoxylated alkylphenol; this material is similar to MACOL OP-10 SP except that OP-10 SP receives a post treatment to remove the catalyst; MACOL OP-10 is no longer commercially available.
⁶⁶TMAZ-81 ethylene oxide derivative of a sorbitol ester which is commercially available from BASF Corp. of Parsippany, New Jersey.
⁶⁷MAZU DF-136 antifoaming agent which is commercially available from BASF Corp. of Parsippany, New Jersey.
⁶⁶ROPAQUE ® OP-96, 0.55 micron particle dispersion which is commercially available from Rohm and Haas Company of Philadelphia, Pennsylvania.
⁶⁹ORPAC BORON NITRIDE RELEASECOAT-CONC 25 boron nitride dispersion which is commercially available from ZYP Coatings, Inc. of Oak Ridge, Tennessee.
⁷⁰POLARTHERM ® PT 160 boron nitride powder which is commercially available from Advanced Ceramics Corporation of Lakewood, Ohio.
⁷¹SAG 10 antiforming material, which is commercially available from Crompton Corporation of Greenwich, Connecticut.
⁷²RD-847A polyester resin which is commercially available from Borden Chemicals of Columbus, Ohio.
⁷³DESMOPHEN 2000 polyethylene adipate diol which is commercially available from Bayer Corp. of Pittsburgh, Pennsylvania.
⁷⁴PLURONIC ® F-108 polyoxypropylene-polyoxyethylene copolymer which is commercially available from BASF Corporation of Parsippany, New Jersey.
⁷⁵ALKAMULS EL-719 polyoxyethylated vegetable oil which is commercially available from Rhone-Poulenc/Rhodia of Princeton, New Jersey.
⁷⁶ICONOL NP-6 alkoxylated nonyl phenol which is commercially available from BASF Corporation of Parsippany, New Jersey.
⁷⁷POLYOX WSR 301 poly(ethylene oxide) which is commercially available from Union Carbide Corp. of Danbury, Connecticut.
⁷⁸DYNAKOLL Si 100 rosin which is commercially available from Eka Chemicals AB, Sweden.
⁷⁹SERMUL EN 668 ethoxylated nonylphenol which is commercially available from CON BEA, Benelux.
⁸⁰SYNPERONIC F-108 polyoxypropylene-polyoxyethylene copolymer; it is the European counterpart to PLURONIC F-108.
⁸¹EUREDUR 140 is a polyamide resin, which is commercially available from Ciba Geigy, Belgium.
⁸²VERSAMID 140 polyamide resin which is commercially available from Cognis Corp. of Cincinnati, Ohio.
⁸³FLEXOL EPO epoxidized soybean oil commercially available from Union Carbide of Danbury, Connecticut.

Additional nonlimiting examples of glass fiber yarns having a resin compatible sizing compositions are disclosed in U.S. Ser. No. 09/620,526 entitled “Impregnating Glass Fiber Strands and Products Including the Same” and filed Nov. 3, 2000, which is specifically incorporated by reference herein.

Referring again to FIG. 1, while not limiting in the present invention, the reinforcement material 20 can comprise from 40 weight percent to 70 weight percent of the prepreg layer 14 (including the weight of the inorganic filler 18). In one nonlimiting embodiment the reinforcement material 20 comprises from 48 weight percent to 66 weight percent of the prepreg layer 14 (including the weight of the inorganic filler 18).

In one nonlimiting embodiment of an electronic support 10 according to the present invention, the electronic support 10 comprises at least one prepreg layer 14 comprising at least one woven fiber reinforcement material 20 formed from at least one fiber free of basalt glass, and at least one matrix material 16 in contact with at least a portion of the at least one reinforcement material 20, the at least one matrix material 16 comprising at least one non-fluorinated polymer and at least one inorganic filler 18, wherein the at least one inorganic filler 18 comprises at least one non-hydratable, lamellar inorganic solid lubricant having a high electrical resistivity and comprises at least 6 weight percent of a total combined weight of the matrix material 16 and the at least one inorganic filler 18 on a total solids basis. Additionally, although not required, the at least one inorganic filler 18 can have one or more of the following attributes: a Mohs' hardness of no greater than 6, a thermal conductivity of greater than 30 W/mK, a low coefficient of thermal expansion, and a high affinity for metal ions. In one nonlimiting embodiment of the present invention of the electronic support 10 discussed above, the at least one particulate inorganic filler 18 is hexagonal boron nitride.

In another nonlimiting embodiment of an electronic support 10 according to the present invention, the electronic support 10 comprises at least one prepreg layer 14 comprising at least one woven fiber reinforcement material 20, and at least one matrix material 16 in contact with at least a portion of the at least one reinforcement material 20, the at least one matrix material 16 comprising at least one non-fluorinated polymer and at least one inorganic filler 18, wherein the at least one inorganic filler 18 comprises at least one non-hydratable, lamellar inorganic solid lubricant having a high electrical resistivity and comprises at least 10 weight percent of a total combined weight of the matrix material 16 and the at least one inorganic filler 18 on a total solids basis. Additionally, although not required, the at least one inorganic filler 18 can have one or more of the following attributes: a Mohs' hardness of no greater than 6, a thermal conductivity of greater than 30 W/mK, a low coefficient of thermal expansion, and a high affinity for metal ions. In one nonlimiting embodiment of the present invention of the electronic support 10 discussed above, the at least one particulate inorganic filler 18 is hexagonal boron nitride.

In another nonlimiting embodiment of an electronic support 10 according to the present invention, the electronic support 10 comprises at least one prepreg layer 14 comprising at least one woven fiber reinforcement material 20 formed from at least one fiber free of basalt glass, and at least one matrix material 16 in contact with at least a portion of the at least one reinforcement material 20, the at least one matrix material 16 comprising at least one non-fluorinated polymer and at least one inorganic filler 18, wherein the at least one inorganic filler 18 comprises at least one inorganic filler having a high thermal conductivity and a high electrical resistivity and comprises at least 6 weight percent of a total combined weight of the matrix material 16 and the at least one inorganic filler 18 on a total solids basis. Additionally, although not required, the at least one inorganic filler can have one or more of the following attributes: a Mohs' hardness of no greater than 6, a thermal conductivity of greater than 30 W/mK, a low coefficient of thermal expansion, good lubricating properties (i.e. is an inorganic solid lubricant), and a lamellar structure. In one nonlimiting embodiment of the electronic support 10 discussed above, the at least one particulate inorganic filler is hexagonal boron nitride.

In another nonlimiting embodiment of an electronic support 10 according to the present invention, the electronic support 10 comprises at least one prepreg layer 14 comprising at least one woven fiber reinforcement material 20, and at least one matrix material 16 in contact with at least a portion of the at least one reinforcement material 20, the at least one matrix material 16 comprising at least one non-fluorinated polymer and at least one inorganic filler 18, wherein the at least one inorganic filler 18 comprises at least one inorganic filler having a high thermal conductivity and a high electrical resistivity, and comprises at least 10 weight percent of a total combined weight of the matrix material 16 and the at least one inorganic filler 18 on a total solids basis. Additionally, although not required, the at least one inorganic filler can have one or more of the following attributes: a Mohs' hardness of no greater than 6, a thermal conductivity of greater than 30 W/mK, a low coefficient of thermal expansion, good lubricating properties (i.e. is an inorganic solid lubricant), and a lamellar structure. In one nonlimiting embodiment of the electronic support 10 discussed above, the at least one particulate inorganic filler is hexagonal boron nitride.

In still another, nonlimiting embodiment of an electronic support 10 according to the present invention, the electronic support 10 comprises at least one prepreg layer 14 comprising at least one fiber reinforcement material 20, and at least one matrix material 16 in contact with at least a portion of the at least one reinforcement material 20, the at least one matrix material 16 comprising at least one inorganic filler 18 in an amount sufficient to inhibit conductive anodic filament formation and reduce electrical shorting within the electronic support. In one particular, nonlimiting embodiment, the at least one fiber reinforcement is a woven glass fiber reinforcement. In another nonlimiting embodiment, the filler has a high affinity for metal ions. Although not required, the filler having a high affinity for metal ions has a CEC of at least 20 meq/100 g, and in another embodiment at least 80 meq/100 g. In another nonlimiting embodiment, the filler having a high affinity for metal ions has a K_{d} (Cu²⁺) of at least 600 ml/g, and in another nonlimiting embodiment of at least 1500 ml/g, and in another nonlimiting embodiment of at least 15,000 ml/g, and in another nonlimiting embodiment of at least 40,000 ml/g. Additionally, although not required, the at least one inorganic filler 18 can further have one or more of the following attributes: a Mohs' hardness of no greater than 6, a low coefficient of thermal expansion, good lubricating properties, high thermal conductivity, and a high electrical resistivity. Nonlimiting examples of fillers having a high affinity for metal ions include, but are not limited to, montmorillonites, vermiculites, saponites, bentonites, hectorites, illites, nontronites, chlorites, attapulgites, porous silicates, synthetic fluoromicas, and mixtures thereof. One nonlimiting embodiment of an expansible synthetic fluoromica is sodium fluorophlogopite. One nonlimiting embodiment of a porous silicate is organofunctionized porous silicate.

In one nonlimiting embodiment of an electronic support 10 according to the present invention, the electronic support 10 comprises at least one prepreg layer 14 comprising at least one woven fiber reinforcement material 20 and at least one matrix material 16 in contact with at least a portion of the at least one reinforcement material 20, the at least one matrix material 16 comprising at least one non-fluorinated polymer and at least one inorganic filler 18, wherein the at least one inorganic filler 18 has a high affinity for metal ions and comprises at least 10 weight percent of a total combined weight of the matrix material 16 and the at least one inorganic filler 18 on a total solids basis. In another nonlimiting embodiment of an electronic support 10, the at least one woven fiber reinforcement material 20 is formed from at least one fiber free of basalt glass and the at least one inorganic filler 18 has a high affinity for metal ions and comprises at least 6 weight percent of a total combined weight of the matrix material 16 and the at least one inorganic filler 18 on a total solids basis.

In another nonlimiting embodiment of an electronic support 10 according to the present invention, the electronic support 10 comprises at least one prepreg layer 14 comprising at least one woven fiber reinforcement material 20 and at least one matrix material 16 in contact with at least a portion of the at least one reinforcement material 20 and at least one inorganic filler 18, wherein the at least one inorganic filler 18 has a high affinity for metal ions and comprises up to 5 weight percent of a total combined weight of the matrix material 16 and the at least one inorganic filler 18 on a total solids basis. In another nonlimiting embodiment of an electronic support 10, the at least one inorganic filler 18 has a high affinity for metal ions and comprises up to 10 weight percent of a total combined weight of the matrix material 16 and the at least one inorganic filler 18 on a total solids basis. In still another nonlimiting embodiment of an electronic support 10, the at least one inorganic filler 18 has a high affinity for metal ions and comprises up to 15 weight percent of a total combined weight of the matrix material 16 and the at least one inorganic filler 18 on a total solids basis.

In another nonlimiting embodiment of an electronic support 10 according to the present invention, the electronic support 10 comprises at least one prepreg layer 14 comprising at least one woven fiber reinforcement material 20 and at least one matrix material 16 in contact with at least a portion of the at least one reinforcement material 20, the matrix materials 16 comprising at least one inorganic filler 18, wherein the at least one inorganic filler 18 is a chelating agent selected from materials having nitrogen containing organic functional groups, sulfur containing organic functional groups, oxygen containing organic functional groups, phosphorus containing organic functional groups, and mixtures thereof. In one nonlimiting embodiment, the chelating agent comprises up to 5 weight percent of a total combined weight of the matrix material 16 and the at least one inorganic filler 18 on a total solids basis. In another nonlimiting embodiment of an electronic support 10, the chelating agent comprises up to 10 weight percent of a total combined weight of the matrix material 16 and the at least one inorganic filler 18 on a total solids basis. In still another nonlimiting embodiment of an electronic support 10, the chelating agent comprises up to 15 weight percent of a total combined weight of the matrix material 16 and the at least one inorganic filler 18 on a total solids basis.

It should also be appreciated that the filler 18 can include a number of different materials, so that together the filler material can provide a combination of properties.

Although not required, if desired, any of the aforementioned embodiments of electronic supports 10 according to the present invention can further comprise an electrically conductive material (not shown) in contact with at least a portion of at least one surface of at least one of the one or more prepreg layers 14. Although not limiting herein, the at least one surface can be an external major surface. As used herein the term “external major surface” means an exposed major surface. Furthermore, the electrically conductive material can comprise at least one circuit. As used herein the term “circuit(s)” means any feature formed in or by an electrically conductive material and includes, for example, but not limiting herein, lines, pads, lands and other features normally formed on printed circuit boards in order to provide the necessary electrical and/or thermal interconnections. The electronic support 10 can also comprise at least one aperture extending at least partially through the electronic support, as discussed in detail below.

With continued reference to FIG. 1, a nonlimiting method of forming an electronic support 10 according to one embodiment of the present invention will be discussed generally. The method comprises combining at least one inorganic filler 18 with at least one matrix material 16. The combining step can be accomplished by any method of combining fillers into polymeric materials that is well known in the art. For example and without limiting the present invention, if the at least one matrix material 16 comprises a thermosetting polymer, a solvent solution of the polymer is formed and then the at least one inorganic filler 18 is mixed into the solution. However, if the at least one matrix material 16 comprises a thermoplastic polymer, the polymer can first be melted and then the at least one inorganic filler 18 can be mixed into the melted polymer. Alternatively, a powder mixture of the thermoplastic polymer and the at least one inorganic filler 18 can be formed and then heated to melt the polymer, or the powder mixture can be mixed and passed through an extruder to form an intimate mixture and the resultant mixture can be calendared to a flat sheet.

It will be recognized by one skilled in the art that the inorganic filler 18 can be pre-treated with a coupling agent or other compatibilizing agent to improve the wetting of the matrix material 16 on the inorganic filler 18. Additionally, although not required in the present invention, a coupling agent can be added to the matrix material prior to the addition of the inorganic filler material to improve wetting. The treatment of inorganic fillers for use in polymeric materials is well known to those skilled in the art and further disclosure of methods of treating particles is not deemed necessary. However, if more information is desired see Handbook of Fillers for Plastics, H. Katz and J. Milewski Eds. (1987), at pages 65-115, which are specifically incorporated by reference herein.

In one nonlimiting embodiment of the present invention, the at least one inorganic filler 18 is pre-treated with at least one solvent that is compatible with the polymeric matrix material 16, formed into a paste, and then dispersed in the polymeric matrix material 16. As used herein the phrase “at least one solvent that is compatible with the polymeric matrix material” means that the at least one solvent is able to at least partially solvate or swell the polymeric matrix material. Although not limiting herein, in one embodiment of the present invention wherein the polymeric matrix material is an epoxy material, the inorganic filler 18 is pre-treated with at least one solvent selected from acetone, dimethylformamide (DMF), methylene chloride, gylcol ether, methyl ethyl ketone (MEK), and mixtures thereof.

After combining or dispersing the at least one inorganic filler 18 in the polymeric matrix material 16, the polymeric matrix material 16 is then applied to the reinforcement material 20 by any method known in the art to form a prepreg. For example and without limiting the present invention, if reinforcement 20 is in the form of a woven glass fiber fabric, the reinforcement 20 can be dipped in a bath containing the polymeric matrix material 16 comprising the at least one inorganic filler 18, and subsequently squeezed between a set of metering rolls to leave a measured amount of matrix material 16 thereon. Alternatively, the polymeric matrix material 16 comprising the at least one inorganic filler 18 can be sprayed onto the reinforcement 20 in any manner well known in the art. Other methods of applying polymeric matrix materials 16 comprising inorganic fillers 18, such as electrostatic coating and painting, are also contemplated in the present invention.

After forming the prepreg 14, the polymeric matrix material 16 is typically at least partially set, for example by passing the prepreg through a drier. As used herein the phrase “at least partially set” means that the polymeric matrix material is at least partially dried, cooled, and/or cured. Thereafter, the prepreg material can be cut to the required size and, if desired, combined with one or more additional prepreg layers. Generally, and without limiting the present invention, in a conventional laminating operation, the prepreg material is then cut (or punched) to a desired size and two or more cut prepreg layers are stacked together, laminated, and cured by pressing the stack, e.g. between polished steel plates, at elevated temperatures and pressures for a predetermined length of time to cure the polymeric matrix and form an electronic support in the form of a laminate 310 (as shown in FIG. 3) of a desired thickness. Methods of forming laminates according to the present invention will be discussed in more detail below.

In one nonlimiting example of a method according to the present invention, filler 18 comprises particulate boron nitride that is pre-treated with acetone to form a paste. The paste is then dispersed in an epoxy resin comprising 45 to 65 weight percent solids (prior to the addition of the boron nitride paste) to form an epoxy resin comprising 13 weight percent to 17 weight percent boron nitride on a total solids basis. The epoxy resin comprising the particulate boron nitride dispersed therein is then applied to a woven, glass fiber reinforcement material to form a prepreg layer. Thereafter, the epoxy resin of the prepreg layer is at least partially set. It has been observed that by pre-treating boron nitride in this manner, the boron nitride can be more easily dispersed in the epoxy resin.

Referring now to FIG. 2, there is shown another nonlimiting embodiment of an electronic support 210 according to the present invention. Electronic support 210 comprises at least one prepreg layer 214 comprising at least one reinforcement material 220 and at least one matrix material 216 in contact with at least a portion of the at least one reinforcement material 220. At least one layer 217 comprising at least one inorganic filler 218 is in contact with at least a portion 224 of at least one surface of prepreg layer 214, e.g. a major surface 226 of the prepreg. Although not required, if desired, the at least one layer 217 can be positioned on one or more selected portions of at least one surface 226 of the prepreg layer 214 to provide at least a partial layer or it can be positioned upon essentially all of at least one surface 226 of prepreg layer 214 to form an essentially continuous layer or plane of filler 218, as discussed below in more detail.

The at least one reinforcement material 220 can comprise any of the reinforcement materials 20 discussed above for use in the electronic supports of the present invention. In one nonlimiting embodiment, the reinforcement material 220 is a glass fiber reinforcement material. In another nonlimiting embodiment, the reinforcement material 220 is a woven glass fiber reinforcement material. In still another nonlimiting embodiment, the reinforcement material 220 is a non-degreased, resin compatible woven glass fiber reinforcement material.

Furthermore, the matrix material 216 can be any of the matrix materials 16 discussed above and can comprise any of the inorganic filler materials 18 discussed above. For example, although not limiting herein, at least one reinforcement material 220 can be a non-degreased, resin compatible woven glass fiber fabric and the matrix material 216 can be an epoxy material comprising up to 40 weight percent hexagonal boron nitride based on a total combined weight of the epoxy material and the boron nitride on a total solids basis.

The layer 217 can comprise one or more of the inorganic fillers discussed above. In one nonlimiting embodiment of the present invention, the at least one inorganic filler 218 is selected from inorganic solid lubricants, high thermal conductivity materials, low thermal expansion materials, materials having a high affinity for metal ions, high electrical resistivity materials (all of which are discussed above), and combinations and mixtures thereof.

In one nonlimiting embodiment of the present invention wherein the at least one inorganic filler 218 is at least one inorganic solid lubricant, the inorganic solid lubricant is selected from hexagonal boron nitride, metal dichalcogenides, boric acid, antimony oxide, talc, and mixtures thereof. In another nonlimiting embodiment, the inorganic solid lubricant is a non-hydratable inorganic solid lubricant having a lamellar structure (discussed above). In still another nonlimiting embodiment, the non-hydratable inorganic solid lubricant having a lamellar structure is hexagonal boron nitride.

In another nonlimiting embodiment of the present invention wherein the at least one inorganic filler 218 is a high thermal conductivity material, the high thermal conductivity material is selected from hexagonal boron nitride, aluminum nitride, graphite, and mixtures thereof. In another nonlimiting embodiment, the high thermal conductivity material has a thermal conductivity of at least 30 W/mK. In still another nonlimiting embodiment of the present invention, the high thermal conductivity material having a thermal conductivity of at least 30 W/mK is hexagonal boron nitride.

In one nonlimiting embodiment of the present invention, wherein the at least one inorganic filler 218 is a low thermal expansion material, the low thermal expansion material is selected from hexagonal boron nitride, spodumene, aluminum titanate, and mixtures thereof. In another nonlimiting embodiment, the low thermal expansion material has a coefficient thermal expansion of no greater than 100×10⁻⁷/° C. over a temperature range of 0° C. to 200° C. In still another nonlimiting embodiment, the low thermal expansion material has a coefficient thermal expansion of no greater than 50×10⁻⁷/° C. over a temperature range of 0° C. to 200° C. In a nonlimiting embodiment of the present invention, low thermal expansion material is hexagonal boron nitride.

In one nonlimiting embodiment of the present invention, wherein the at least one inorganic filler 218 is a material having a high affinity for metal ions, the material has a CEC of at least 20 meq/100 g, and in another nonlimiting embodiment, has a CEC of at least 80 meq/100 g. In another nonlimiting embodiment, the filler having a high affinity for metal ions has a K_{d} (Cu²⁺) of at least 600 ml/g, and in another nonlimiting embodiment of at least 1500 ml/g, and in another nonlimiting embodiment of at least 15,000 ml/g, and in another nonlimiting embodiment of at least 40,000 ml/g. Nonlimiting examples of fillers having a high affinity for metal ions include, but are not limited to, montmorillonites, vermiculites, saponites, bentonites, hectorites, illites, nontronites, chlorites, attapulgites, porous silicates, synthetic fluoromicas, and mixtures thereof. One nonlimiting embodiment, the expansible synthetic fluoromica is sodium fluorophlogopite. One nonlimiting embodiment, the porous silicate is organofunctionized porous silicate.

In another nonlimiting embodiment of the present invention, the at least one inorganic filler 218 is a chelating agent selected from materials having nitrogen containing organic functional groups, sulfur containing organic functional groups, oxygen containing organic functional groups, phosphorus containing organic functional groups, or a combination thereof.

In one nonlimiting embodiment of the present invention, wherein the at least one inorganic filler 218 is a high electrical resistivity material, the high electrical resistivity material is selected from of boron nitride, talc, mica, and mixtures thereof. In one nonlimiting embodiment, the high electrical resistivity material has an electrical resistivity of at least 1000 μΩ-cm. Although not limiting in the present invention, in one embodiment the high electrical resistivity material having an electrical resistivity of at least 1000-μΩ cm is hexagonal boron nitride.

In still another nonlimiting embodiment of the present invention, the at least one inorganic filler 218 has a Mohs' hardness value no greater than that of the at least one reinforcement material 220. In another nonlimiting embodiment, the at least one inorganic filler 218 has a Mohs' hardness value no greater than 6. Although not limiting in the present invention, in one embodiment the inorganic filler 218 having a Mohs' hardness value no greater than 6 is hexagonal boron nitride.

Although not limiting herein, the at least one inorganic filler 218 of the at least one layer 217 can comprise from 5 weight percent to 35 weight percent of a total combined weight of the matrix material 216 and the at least one layer 217 on a total solids basis. In one nonlimiting embodiment, the at least one inorganic filler 218 comprises from 10 weight percent to 30 weight percent of the matrix material 216 and the at least one layer 217 on a total solids basis. In still another nonlimiting embodiment, the at least one inorganic filler 218 comprises from 12 weight percent to 28 weight percent of a total combined weight of the matrix material 216 and the at least one layer 217 on a total solids basis.

Layer 217 can further comprise other materials in addition to the inorganic filler materials discussed above. For example, although not limiting in the present invention, the layer 217 can comprise organic lubricants, such as polytetrafluoroethylene and stearates (such as zinc stearate); particulate organic fillers, such as rubber particles; and adhesive materials (discussed below).

Although not limiting herein, in one embodiment of the present invention, the at least one layer 217 comprises no greater than 25 weight percent of adhesive materials based on a total weight of the at least one layer 217 on a total solids basis. In another nonlimiting embodiment, the at least one layer 217 comprises no greater than 10 weight percent of adhesive materials based on a total weight of the at least one layer 217 on a total solids basis. In another nonlimiting embodiment, the at least one layer 217 comprises no greater than 5 weight percent of adhesive materials based on a total weight of the at least one layer 217 on a total solids basis. As used herein, the term “adhesive materials” means polymeric materials added to layer 217 to support adhesion between layer 217 and other materials, such as other prepreg layers or electrically conductive layers. Adhesive materials can have the same chemical composition as the matrix material 216 or they can have a different chemical composition.

It will be recognized by one skilled in the art that the incorporation of adhesive materials into layer 217 can increase the overall resin (polymer) content of prepreg layer 214 as compared to prepreg layers comprising layers 217 that are essentially free of such adhesive materials. Such increases in the overall resin content can be detrimental to the properties of electronic support incorporating the prepreg layers. As a result, although not limiting herein, if adhesive materials are incorporated into layer 217, the amounts of adhesive material and polymeric matrix material 216 can be adjusted such that the overall resin content of prepreg layer 214 (based on the total combined weight of the reinforcement material 220, the polymeric matrix material 216, and the layer 217 on a total solids basis) ranges from 25 to 45 weight percent. In one nonlimiting embodiment, the amounts of adhesive material and polymeric matrix material 216 are adjusted such that the overall resin content of prepreg layer 214 ranges from 28 to 42 weight percent.

In another nonlimiting embodiment of the present invention, layer 217 is essentially free of adhesive materials. As used herein, the phrase “essentially free of adhesive materials” means that layer 217 comprises no greater than 0.1 weight percent of adhesive materials based on the total weight of the at least layer 217 on a total solids basis, and preferably comprises no adhesive materials.

As discussed in more detail below, prepreg layer 214 of electronic support 210 can be a first prepreg layer and electronic support 210 can further comprise at least one additional prepreg layer (not shown in FIG. 2 but shown in FIG. 3) laminated to at least a portion of the first prepreg layer 214. In one nonlimiting embodiment of the present invention, the at least one layer 217 is positioned between the at least one additional prepreg layer and the first prepreg layer 214 to form a laminate. In another nonlimiting embodiment, first and prepreg layers are combined in a manner such that layer 217 is at least partially exposed.

If desired and although not required, an electrically conductive material (not shown in FIG. 2) can also be positioned on at least one external surface of the electronic support 210 and, as discussed in more detail below, at least one circuit can be formed in the electrically conductive material.

Although not limiting herein, in one embodiment, the at least one layer 217 is positioned upon at least a portion of a first surface 226 of the prepreg layer 214 and the electrically conductive material is positioned upon at least a portion of a second, opposing surface 228 of the prepreg layer 214.

If desired, although not required, the electronic support 210 can further comprise at least one aperture extending at least partially through the electronic support, as discussed below.

Nonlimiting methods of forming electronic supports 210 will now be discussed generally. Referring again to FIG. 2, a prepreg layer 214 comprising at least one matrix material 216 and at least one reinforcement material 220 is formed in a conventional manner, and the at least one matrix material 216 is at least partially set. Thereafter at least a portion of the at least partially set matrix material 216 is at least partially solvated and at least one inorganic filler 218 is adhered to at least a portion of the at least partially solvated polymeric matrix material 226 to form the at least one layer 217. If desired, additional layers of matrix material and/or inorganic fillers 218 (not shown) can then be applied over and added to the layer 217 and at least partially set, as discussed earlier. The prepreg can then be further processed into a laminate as discussed below.

In one nonlimiting embodiment of the invention, after prepreg layer 214 is at least partially set, at least a layer 217 comprising at least one inorganic filler 218 can be adhered to at least a portion 224 of at least one surface 226 of prepreg layer 214 by spraying on an aerosol comprising the at least one inorganic filler 218 and a propellant, and if desired a solvent that is compatible with the at least one polymeric matrix material. A nonlimiting example of an aerosol form of an inorganic filler that is suitable for use in the present invention is Boron Nitride Aerosol Lubricant which contains, boron nitride, acetone, and a propellant and is commercially available from ZYP Coatings, Inc. of Oak Ridge, Tenn.

Alternatively, although not limiting in the present invention, the at least one layer 217 comprising at least one inorganic filler 218 can be applied to at least a portion 224 of at least one surface 226 of prepreg layer 214 by dip coating prepreg layer 214 in a solvent bath comprising at least one solvent and the at least one inorganic filler 218. For example, although not limiting, the prepreg layer 214 can be at least partially immersed in the solvent bath comprising at least one solvent that is compatible with the at least one polymeric matrix material 216 and the at least one inorganic filler 218, removed from the bath, and then dried to form a prepreg layer 214 comprising the at least one partial layer 217 positioned upon at least a portion 224 of at least one surface 226 thereof.

Preferred solvents for use in the aforementioned methods of forming layer 217 include, but are not limited to, solvents that are compatible with the at least one polymeric matrix material 216 used to form prepreg layer 214. Although not meant to be bound by any particular theory, it is contemplated that by using such solvents, the surface of the prepreg will become tacky due to partial salvation of the at least one polymeric matrix material 216 when the prepreg is brought in contact with the solvent, thereby facilitating the adherence of the at least one inorganic filler to the surface of the prepreg. Furthermore, it is contemplated that tackifying the surface of the prepreg layers in such a manner will facilitate lamination of the prepreg layers by reducing slip between the prepreg layers when stacked. It will be recognized by one skilled in the art that the selection of solvent will depend upon several factors such as, but not limited to, the polymeric matrix material 216 used to form the prepreg and the desired amount of salvation. Nonlimiting examples of solvents for use with prepregs comprising polymeric matrix materials comprising epoxy include acetone, dimethylformamide (DMF), methylene chloride, glycol ethers, such as methoxy isopropanol, other ketones, such as methyl ethyl ketone (MEK), and mixtures thereof. Although not required, the solvent bath can further comprise, for example, polymeric matrix materials (such as epoxy), adhesive materials, particulate organic fillers, and other processing aids such as dispersants for the at least one inorganic filler 218. It will be appreciated by one skilled in the art that the type and amount of solvent can be controlled to produce the desired level of salvation for a given polymeric matrix material 216.

Although not required, if desired, portions of the surface of prepreg layer 214 can be masked, in any manner known in the art, prior to coating to prevent the adherence of the at least one inorganic filler 218 in the masked regions. For example, although not limiting in the present invention, masking tape can be applied to selected portions of the surface 226 of prepreg 214 prior to the application of the inorganic filler 218, to prevent adherence of the inorganic filler 218 of layer 217 to the selected portions of the prepreg surface. Furthermore, any or all of the surfaces of prepreg layer 214 can be at least partially or entirely coated with the at least one inorganic filler 218 to form a continuous plane or layer 217.

In another nonlimiting method of forming electronic support 210 in accordance with the present invention, the at least one polymeric matrix material 216 can be applied to the at least one reinforcement material 220, and then the at least one layer 217 comprising at least one inorganic filler 218 can be applied to at least a portion 224 of at least one surface 226 of prepreg layer 214 while the polymer is still tacky, i.e. prior to at least partially setting the at least one polymeric matrix material 216 as previously discussed. The inorganic filler 218 can be applied, for example, by spraying or blowing the filler 218 onto the portion 224 of the surface 226, or electrostatically depositing the filler 218 on portions 224 of surface 226 while polymeric matrix material 216 is at least partially tacky. If desired, additional layers of polymeric matrix material and/or inorganic fillers 218 (not shown) can then be applied over the layer 217 and at least partially set. The prepreg can then be further processed into a laminate as discussed below.

Referring now to FIG. 3, there is shown an electronic support 310 comprising a laminate 312 comprising a first prepreg layer 314, a second prepreg layer 315 adjacent a surface 326 of the first prepreg layer 314, and an at least one layer 317 comprising at least one inorganic filler 318 between the first prepreg layer 314 and the second prepreg layer 315. In one nonlimiting embodiment of the invention and as previously discussed, the at least one layer 317 comprises no greater than 25 weight percent adhesive materials based on a total weight of the at least one partial layer on a total solids basis. In one nonlimiting embodiment, at least one layer 317 is essentially free of adhesive materials.

Although not limiting in the present invention, as shown in FIG. 3, the first prepreg layer 314 of laminate 312 comprises at least one reinforcement material 320, at least one polymeric matrix material 316 in contact with at least a portion of the at least one reinforcement material 320, and the at least one layer 317 comprising at least one inorganic filler 318 positioned on at least a portion 324 of surface 326 of the prepreg layer 314; and the second prepreg layer 315 comprises at least one reinforcement material 321, at least one polymeric matrix material 336 in contact with at least a portion of the at least one reinforcement material 321. Although not required, in one nonlimiting embodiment of the invention, reinforcement materials 320 and 321 are the same and polymeric matrix materials 316 and 336 are the same.

Although not required, if desired, prepreg layer 315 can also comprise a layer (not shown in FIG. 3) similar to layer 317 of prepreg 314 applied to at least a portion of at least one surface of prepreg layer 315. It will be appreciated by those skilled in the art that the laminate 312 can further comprise one or more additional prepreg layers (not shown) and that the one or more additional prepreg layers can, if desired, further comprise one or more layers similar to layer 317.

In one nonlimiting embodiment of an electronic support in the form of a laminate according to the present invention, the laminate comprises a plurality of prepreg layers laminated together such that at least one layer comprising at least one inorganic filler is positioned between at least a portion of at least one pair of adjacent prepreg layers. In another nonlimiting embodiment, the laminate comprises a plurality of prepreg layers laminated together such that at least one layer comprising at least one inorganic filler is positioned between at least a portion of each pair of adjacent prepreg layers.

Referring to FIG. 3, in one nonlimiting embodiment of the invention, the laminate comprises a plurality of prepregs, wherein one or more prepreg layers 314 comprise at least one layer 317 comprising at least one inorganic filler 318 in contact with at least a portion 324 of at least one surface 326 of the prepreg and/or one or more prepreg layers 315 comprising at least one reinforcement material 321 and at least one polymeric matrix material 336 comprising at least one inorganic filler 319 in contact with at least a portion of the reinforcement material 321, as discussed above. In another nonlimiting embodiment, the laminate comprises at least one prepreg layer that comprises both an at least one layer comprising at least one inorganic filler in contact with at least a portion of at least one surface of the prepreg and at least one reinforcement material and at least one polymeric matrix material comprising at least one inorganic filler in contact with at least a portion of the reinforcement material. In yet another embodiment, the laminate comprises one or more prepreg layers that are essentially free of inorganic fillers in addition to the prepreg layers discussed above.

Now referring to FIGS. 2 and 3, the aforementioned methods of forming electronic supports 210, 310 in the form of prepregs 214 and laminates 312 are believed to be advantageous in that the methods allow for at least one layer 217, 317 comprising at least one inorganic filler 218, 318 to be incorporated into the electronic supports 210, 310 without having to mix high volume fractions of the inorganic fillers directly into the polymeric matrix materials 216, 316 prior to impregnation of the reinforcement material 220, 320. Additionally, the location and distribution of layers 217, 317 on the surface 226, 326 of prepreg layer 214, 314 can be more carefully controlled by these methods, thereby allowing for a designed distribution of the inorganic fillers 218, 318 within the electronic supports 210, 310 itself.

Additionally, as shown in FIG. 3, if desired the at least one layer 317, when incorporated into a laminate 312, can form an essentially continuous internal layer or plane within the laminate 312. Thus, by selecting the inorganic filler material 318 to have particular properties, for example, but not limiting herein, high thermal conductivity, good lubricating properties, low thermal expansion, low electrical conductivity, and/or high affinity for metal ions, the functionality and performance of electronic supports 310 can be improved. This is particularly advantageous when the electronic support 310 is used to form a PCB. For example, although not limiting herein, if the at least one inorganic filler 318 is selected to have high thermal conductivity, the continuous internal layer formed by layer 317 comprising the inorganic filler 318 can act as a heat spreader in the PCB, which can improve the performance of active devices mounted thereon. Furthermore, such an internal layer could enhance the yield in assembly processes by reducing or eliminating differential thermal expansion and warpage of the PCB during assembly by dissipating or spreading the heat from soldering and other attach processes uniformly across the PCB.

In another nonlimiting example, a continuous layer 317 of electronic support 310 can comprise at least one inorganic filler 318 that has a low thermal expansion which, as previously discussed, can provide for reduced barrel cracking in plated apertures formed in PCB .

In yet another nonlimiting example, a continuous layer 317 can comprise at least one inorganic filler 318 that has a high affinity for metal ions which, as previously discussed, can provide prevent electrical shorts due to conductive anodic filament formation within the PCB.

In another nonlimiting example of an electronic support that is particularly desirable for use in mechanical drilling operations, layer 317 can comprise a lubricant. More specifically, electronic support 310 can comprise a laminate 312 comprising a stack of prepreg layers 314, 315 laminated together; and a layer 317 comprising a lubricant. As discussed earlier, layer 317 can be positioned between at least one pair of adjacent prepreg layers of the stack of prepreg layers or along one of the external major surfaces of the support. As used herein, the term “stack” means at least two items, e.g. prepregs layers, laminates, electronic supports, etc. arrangement in overlaying relation so as to form a pile of such items. Although not limiting herein, in one embodiment the layer 317 comprises a lubricant, and further comprises no greater than 25 weight percent adhesive materials based on the total weight of the layer on a total solids basis. Lubricants include, but are not limited to, inorganic solid lubricants and organic lubricants. Inorganic solid lubricants include, but are not limited to, hexagonal boron nitride, boric acid, molybdenum disulfide, graphite, and mixtures thereof. Organic lubricants include, but are not limited to, polytetrafluoroethylene, zinc stearate, and mixtures thereof.

A nonlimiting method of forming an electronic support that is particularly desirable for use in mechanical drilling operations will now be described generally. The method comprises applying a lubricant material to at least a portion of at least one major surface of a first prepreg layer to form a lubricant layer, stacking the first prepreg layer with one or more additional prepreg layers such that the lubricant layer is positioned between the first prepreg layer and at least one of the one or more additional prepreg layers to form an internal lubricant layer, and laminating the first prepreg layer and one or more additional prepreg layers together to form an electronic support. Although not required, if desired at least one of the one or more additional prepreg layers can comprises a lubricant layer positioned upon at least a portion of at least one surface thereof.

In another nonlimiting embodiment of a method of forming an electronic support in the form of a laminate according to the present invention, the inorganic filler can be first applied to desired portions of the reinforcement material and then the polymeric matrix material can be applied thereon. For example, although not limiting, the inorganic filler can be electrostatically deposited onto the reinforcement material or the reinforcement can be dipped into a slurry of the inorganic filler and a solvent, preferably water. After coating the reinforcement material, a polymeric matrix material can be applied to the reinforcement material over the inorganic filler, such as by spraying or dip coating. The polymeric matrix material can then be partially set. Although not required, if desired, additional layers of inorganic filler can be applied to the polymeric material prior to or after drying as discussed above in detail. Thereafter, the polymeric material can be at least partially set and/or additional layers of polymeric matrix material and/or inorganic filler can be built up on the reinforcement as desired. The prepreg material can then be cut and laminated as described above to form an electronic support in the form of a laminate.

In another, nonlimiting embodiment of the present invention, the reinforcement is formed using a wet-laid paper making process, wherein the at least one inorganic filler is applied to the paper reinforcement during formation thereof. For example and although not limiting in the present invention, a glass fiber paper reinforcement can be formed by dispersing chopped glass fiber strands into a white water solution along with an inorganic filler material. As used herein, the term “white water solution” means a solution, for example an aqueous solution, which can comprise dispersants, thickeners, softening and hardening chemicals, and dispersed or emulsified polymers. Such white water solutions are well known to those skilled in the art. If additional information is required, see U.S. Pat. No. 5,393,379, which is specifically incorporated by reference herein. The dispersion or slurry can then be deposited into a head box and subsequently cast, i.e. deposited, onto a moving wire screen to form a glass fiber sheet. The sheet can then be at least partially dried by a suction or vacuum device to form a filled, glass fiber paper reinforcement, i.e. a glass fiber paper reinforcement incorporating the filler. Thereafter, a polymer matrix material can be applied to the paper reinforcement as discussed above in detail to form a prepreg layer in accordance with the present invention. If desired, inorganic fillers can be incorporated into the polymeric matrix material applied to the paper reinforcement as previously discussed and/or a layer comprising one or more inorganic filler materials can be applied to the prepreg layer. Two or more prepreg layers can then be stacked and laminated as discussed above.

In another nonlimiting example of a wet-laid paper process that can be used to form a filled, glass fiber paper reinforcement according to the present invention, chopped glass fibers and one or more inorganic fillers are dispersed in water along with one or more foaming agents. A nonlimiting example of a foaming agent suitable for use in the present invention is TRITON X100, which is a ethoxylated octylphenol that is commercially available Union Carbide Corporation of Danbury, Conn. The dispersion is then agitated to form a foamed slurry, which is then cast onto a web, and the foam is vacuumed away and at least partially dried to form a filled, glass fiber paper reinforcement. Thereafter, a polymer matrix material can be applied to the paper reinforcement as discussed above in detail to form a prepreg layer in accordance with the present invention. If desired, inorganic fillers can be incorporated into the polymeric matrix material applied to the paper reinforcement as previously discussed and/or a layer comprising one or more inorganic filler materials can be applied to the prepreg layer. Two or more prepreg layers can then be stacked and laminated as discussed above.

The present invention further contemplates electronic supports in the form of clad laminates and printed circuit boards made from the prepreg layers and laminates described above in detail. Referring back to FIG. 3, the electronic supports 310 according to the present invention can comprise an electrically conductive layer 322 comprising electrically conductive material in contact with at least a portion 325 of at least one surface 327 of the laminate 312 to form a clad laminate 313.

The layer 322 of electrically conductive material can be formed by any method well known to those skilled in the art. For example, but not limiting the present invention, the electrically conductive layer 322 can be formed by laminating a thin sheet or foil of electrically conductive material, such as but not limited to metallic material, onto the at least portion 325 of surface 327 of a semi-cured or cured prepreg 315 or laminate 312. As an alternative, the electrically conductive layer 322 can be formed by depositing a layer of electrically conductive material onto the at least portion 325 of surface 327 of the semi-cured or cured prepreg 315 or laminate 312 using well known techniques including, but not limited to, electrolytic plating, electroless plating or sputtering.

Electrically conductive materials suitable for use as an electrically conductive layer 322 include, but are not limited to, copper, silver, aluminum, gold, tin, tin-lead alloys, palladium, and combinations and alloys thereof.

With continued reference to FIG. 3, a nonlimiting method of forming a clad laminate 313 according to the present invention will now be discussed generally. The method comprises stacking together two or more prepreg layers 314, 315 at least one of which is made in accordance one of the methods previously discussed for making prepregs in accordance with the present invention, and one or more layers 322 of an electrically conductive material 323, and laminating the prepreg layers 314, 315 and the electrically conductive layer(s) 322 together to form a clad laminate 313. Although not limiting herein, in one embodiment at least one of the one or more layers of the electrically conductive material 323 is positioned such that it is present on at least one external major surface 327 of the clad laminate 313.

It will be recognized by those skilled in the art that the prepregs, laminates and clad laminates of the present invention are useful in forming multilayer printed circuit boards that are well known in the art. As used herein the term “multilayer printed circuit board” means a printed circuit board having at least one internal layer of an electrically conductive material. The internal layer can be present as an essentially continuous plane (i.e. a power or ground plane) or it can be patterned with one or more circuits as discussed below.

A nonlimiting method of forming a printed circuit board in accordance with the present invention will now be described generally. The method comprises forming a clad laminate according to the present invention as discussed above, and patterning one or more circuits on at least a portion of at least one electrically conductive layer of the clad laminate by any manner well known in the art. For example, although not meant to be limiting herein, a photoresist can be applied to the electrically conductive layer, photo-imaged, and developed according to practices that are well known in the art. Thereafter, the exposed electrically conductive material can be etched away to form circuits on the surface of the electronic support. Such methods are well known in the art and the foregoing example is meant only to be illustrative of one suitable method of patterning circuits and not meant to be limiting in the present invention. In addition to or in lieu of forming the one or more circuits on at least one surface of the laminate, one or more apertures or vias extending at least partially through the electronic support can be drilled or punched into the electronic support by any method well known in the art, such as but not limited to mechanical or laser drilling, to form a circuit board in accordance with the present invention.

Nonlimiting methods of forming apertures in electronic supports and, in particular, in printed circuit boards according the present invention will now be discussed generally.

Typically, apertures are formed in an electronic support by drilling the support, most commonly by means of a mechanical drilling process, to allow for electrical interconnection between circuits to be patterned upon opposing surfaces of the electronic support. After formation of the apertures, a layer of electrically conductive material is deposited on the walls of the aperture and/or the aperture is filled with an electrically conductive material to facilitate the required electrical interconnection and/or heat dissipation. As previously discussed, the drilling step is a critical step in determining not only the quality of the printed circuit board fabricated, but also the overall production yield and cost. If the drilled holes are not accurately positioned, or the walls of the holes are rough, resin smeared or otherwise defective panels may have to be scrapped. Furthermore, if drilling defects occur after the patterning of the circuitry, the cost of scrapping the panel rises significantly. It has been observed that as the aperture forming device used to form the apertures in a printed circuit board or electronic support becomes worn during drilling, the quality and locational accuracy of the drilled holes and the overall quality of the board decreases. As a result, production yields drop, causing increased production costs.

The methods of forming apertures according to the present invention are particularly advantageous in the formation of apertures in electronic supports during the production of printed circuit boards, in that it is believed they can potentially provide for increased drill life, decreased drill tool wear, improved hole wall quality and hole locational accuracy, and reduced drilling cost. Furthermore, the present methods and apparatus can be incorporated into existing drilling operations without the need for significant equipment modification or additional processing steps. It is further contemplated that other printed circuit board processing operations, such as routing, edging, dicing and finishing can benefit from the methods disclosed herein.

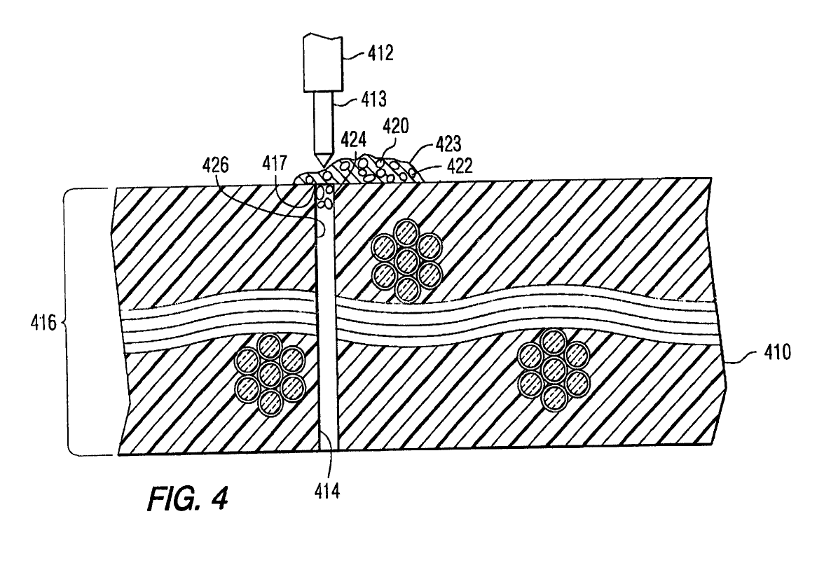

A nonlimiting method of forming an aperture in an electronic support according to the present invention will now be discussed generally. Referring to FIG. 4, the method comprises locating an electronic support 410 in registry with an aperture forming device 412. Although not meant to be limiting, the electronic support 410 is an electronic support formed in a manner as discussed in detail above and can include matrix material and/or layers incorporating filler materials as disclosed herein. Nevertheless, the methods of the present invention also suitable for use with conventional electronic supports that are readily commercially available from a variety of manufacturers. As used herein the term “aperture forming device” means any device capable of mechanically forming an aperture in an electronic support. Although not limiting in the present invention, in the embodiment shown in FIG. 4, the aperture forming device 412 uses a drill bit 413 to form aperture 414. Examples of commercially available aperture forming devices 412 that are suitable for use in the present invention include, but are not limited, to a Hitachi-H Mark 10D 5 head (spindle) machine, a Uniline 2000 single head machine, and a Pluritec single spindle, multistation drilling machine.

After locating the electronic support 410 in registry with the aperture forming device 412, an aperture 414 extending at least partially through the thickness 416 of the electronic support 410 is formed by bringing the aperture forming device 412 into contact with and penetrating at least a portion 417 of the electronic support 410. In one nonlimiting embodiment of the invention, a fluid stream 420 comprising a solid lubricant 422 and a carrier 423 is dispensed proximate the aperture forming device 412 during at least a portion of the aperture forming operation such that the solid lubricant 422 contacts at least a portion 424 of an interface 426 between the drill bit 413 of the aperture forming device 412 and the electronic support 410 as the drill bit advances through the electronic support 410. It should be appreciated that the method discussed above can be used to form apertures in laminates incorporating filler material as disclosed herein as well as in conventional laminates.

In one nonlimiting embodiment of the present invention, the solid lubricant 422 is preferably an inorganic solid lubricant. Any of the inorganic solid lubricants discussed above for use as an inorganic filler material 18 (shown in FIG. 1) can be used as the inorganic solid lubricant 422 in accordance with the method of forming apertures according to the present invention. In one nonlimiting embodiment, the inorganic solid lubricant 422 is an inorganic solid lubricant material having a lamellar structure. For example, although not limiting herein, suitable inorganic solid lubricant particles having a lamellar structure include boron nitride, boric acid, graphite, metal dichalcogenides, mica, talc, kaolinite, cadmium iodide, and mixtures thereof. Suitable metal dichalcogenides include, but are not limited to, molybdenum disulfide, molybdenum diselenide, tantalum disulfide, tantalum diselenide, tungsten disulfide, tungsten diselenide, and mixtures thereof. In one nonlimiting embodiment of the present invention, the inorganic solid lubricant for use in the fluid stream 420.

Nonlimiting examples of boron nitride particles suitable for use in the present invention include the POLARTHERM hexagonal boron nitride particles discussed above.

The carrier 423 of the fluid stream 420 can be either a liquid or a gas. If the carrier 423 is a liquid, the solid lubricant 422 can be present as dispersion, suspension or emulsion in the liquid. Nonlimiting examples of suitable liquid carriers include water; oils, such as mineral oil or petroleum based-oils; alcohol; and other organic solvents, such as acetone, methyl ethyl ketone (MEK), methylene chloride, toluene; and mixtures thereof. A nonlimiting example of a dispersion is ORPAC BORON NITRIDE RELEASECOAT-CONC 25, which is a dispersion of 25 weight percent hexagonal boron nitride particles in water and is commercially available from ZYP Coatings, Inc. of Oak Ridge, Tenn. See, “ORPAC BORON NITRIDE RELEASECOAT-CONC,” a technical bulletin of ZYP Coatings, Inc. which is specifically incorporated by reference herein. According to the supplier, the hexagonal boron nitride particles in this product have an average particle size of less than 3 micrometers. This dispersion also includes 1 percent of magnesium-aluminum silicate, which according to the supplier functions as a suspending agent to keep the boron nitride from settling and can aid in binding the hexagonal boron nitride particles to the substrate to which the dispersion is applied. Independent testing of a sample of ORPAC BORON NITRIDE RELEASECOAT-CONC 25 boron nitride using a Beckman Coulter LS 230 particle size analyzer found an average particle size of 6.2 micrometers, with particles ranging from submicrometer to 35 micrometers and having the following distribution of particles:

| % > | 10 | 50 | 90 |
|---|---|---|---|
| Size (μm) | 10.2 | 5.5 | 2.4 |

According to this distribution, ten percent of the ORPAC BORON NITRIDE RELEASECOAT-CONC 25 boron nitride particles that were measured had an average particle size greater than 10.2 micrometers.

Other useful products which are commercially available from ZYP Coatings, Inc. of Oak Ridge, Tenn. include BORON NITRIDE LUBRICOAT® paint, BRAZE STOP and WELD RELEASE products. Nonlimiting examples of gaseous carriers believed to be useful in the present invention include compressed air, nitrogen, argon, and can also include, propellants such as butane or propane (which are not necessarily preferred due to their flammability).

Although not meant to be bound by any particular theory, it is believed that by dispensing a fluid stream 420 comprising a solid lubricant 422 proximate the aperture forming device 412 such that the solid lubricant 422 contacts a portion 424 of the interface 426, the abrasive wear of the drill bit 413 during drilling can be reduced, thereby increasing drill life. Furthermore, it is believed that the heat generated during drilling will be reduced by reducing the friction between the aperture forming device 412 and the electronic support 410, thereby reducing resin smear in the drilled aperture 414. It is further believed that the reduction of generated heat can be increased by using a solid lubricant having a high thermal conductivity, such as but not limited to hexagonal boron nitride, to conduct the heat away from the interface 426 and thereby reduce the incidents of resin smear. Solid lubricants having high thermal conductivity that are suitable for use in the fluid stream 420 include, but are not limited to, those that have been disclosed above for use as inorganic fillers 18, 218 (shown in FIGS. 1 and 2).

The fluid stream 420 can be dispensed in by any method known in the art. For example, the fluid stream 420 can be sprayed through a nozzle or atomizer (not shown). In one, nonlimiting embodiment of the present invention, the fluid stream comprising a solid lubricant and a liquid carrier is provided through a hollow channel (not shown) extending at least partially through an interior portion of drill bit 413 of aperture forming device 412. The fluid stream 420 is dispensed at the interface between the drill bit and the electronic support by passing the fluid stream through the hollow channel and out at least one hole extending from an external surface of the drill bit into the hollow channel. Other methods of dispensing fluid streams 420 comprising solid lubricants 422 and a liquid carrier 423 include, but are not limited to, painting and dipping the electronic support 410 to coat it with the solid lubricant 422 immediately prior to drilling.

The size and number of apertures 414 formed in the electronic support 410 can vary as required. Although not limiting, for example, apertures 414 having diameters ranging from 0.025 millimeters (0.001 inches) to 12.7 millimeters (0.50 inches) can be formed in the electronic support 410 in accordance with the methods of the present invention.

The apertures 414 formed in the electronic support 410 can extend partially through the thickness 416 of the electronic support (e.g. blind vias or buried vias), or they can extend completely through the thickness 416 of the electronic support 410 as shown in FIG. 4 (e.g. through holes). Furthermore, if desired, the electronic support 410 can include one or more of each type of aperture 414 described above, as well as different diameter apertures. Moreover, if desired, the apertures 414 can be filled with an electrically conductive material, such as solder.

In another, nonlimiting embodiment of a method of forming an aperture in an electronic support according to the present invention, an electronic support is located in registry with an aperture forming device, and a fluid stream comprising a solid lubricant is impinged onto the aperture forming device. The aperture forming device is then brought into contact with at least a portion of the electronic support and an aperture extending at least partially through the thickness of the electronic support is formed. The fluid stream can be supplied on an intermittent basis, i.e. during at least a portion of the aperture forming operation, or it can continuously impinge onto the aperture forming device during the aperture forming step.

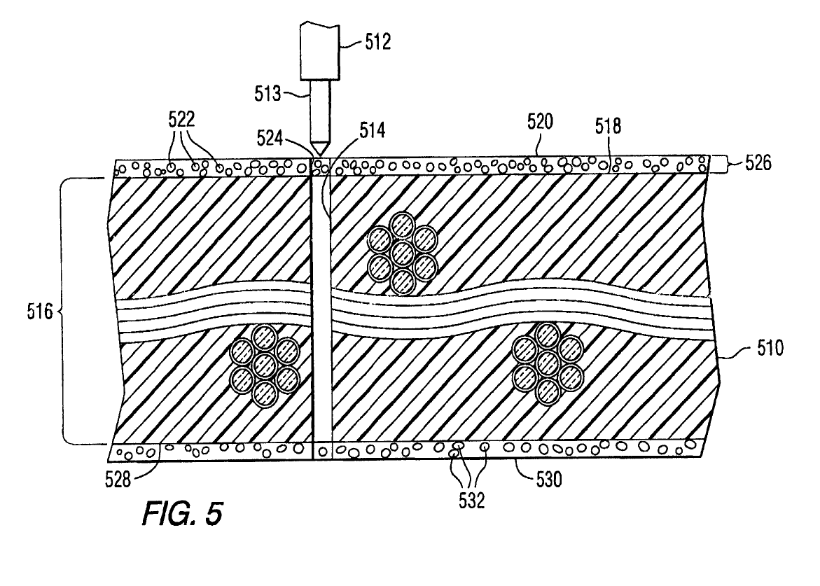

Referring now to FIGS. 5-7, in another nonlimiting embodiment of a method of forming an aperture in an electronic support according to the present invention, an electronic support 510 is located in registry with an aperture forming device 512 such that a surface 518 of the electronic support 510 is in close proximity to the aperture forming device 512. A layer 520 comprising an inorganic solid lubricant material 522 is positioned along at least a portion of the upper surface 518 of the electronic support 510 between the upper surface 518 of the electronic support 510 and the aperture forming device 512. An aperture 514 extending at least partially through thickness 516 of the electronic support 510 is then formed by the drill bit 513 of aperture forming device 512. In so doing, drill bit 513 also forms an aperture 524 extending completely through thickness 526 of layer 520. If desired, a second layer 530 comprising an inorganic solid lubricant 532 can be positioned along an opposing surface 528 of the electronic support 510 as shown in FIG. 5.

In one nonlimiting embodiment, the layer 520 is a single layer. As used herein, the term “single layer” in reference to layer 520 means that that layer 520 is not supported on a secondary support substrate. Layer 520 can be a single layer applied directly to the surface 518 of the electronic support 510 or it can be a self-supporting layer that is interposed between the surface 518 and the aperture forming device 512 prior to drilling.

In another nonlimiting embodiment, the layer 520 is positioned on surface 518 such that the solid lubricant 522 is in direct contact with the surface 518 of the electronic support 510. In this particular embodiment, the layer 520 can be a single layer, as discussed above, or it can be comprised of multiple layers. For example, although not limiting in the present invention, the layer 520 can be laminated to or otherwise adhered to a secondary support substrate (not shown) to provide support to the layer 520 prior to positioning layer 520 between the surface 518 of the electronic support 510 and the aperture forming device 512.

In another nonlimiting example according to the present invention, wherein the inorganic solid lubricant is hexagonal boron nitride, a layer of hexagonal boron nitride can be applied directly to an exterior surface of a phenolic-paper entry board by spraying or painting a dispersion of boron nitride (discussed above) onto the surface thereof. Such entry board materials are well known in the art and are commercially available from Centerline of Baltimore, Maryland as “thick paper core phenolic back up EB-95”. A layer of hexagonal boron nitride can also be applied directly to the electronic support 510 by spraying or painting a dispersion of boron nitride onto a surface 518 of the electronic support 510, for example an upper surface, in an amount sufficient to provide the desired drilling properties as the drill bit first penetrates the boron nitride before forming aperture 514.

Although not meant to be bound by any particular theory, it is believed that when the drill bit 513 of aperture forming device 512 cuts through the lubricating layer 520, a portion of the inorganic solid lubricant 522 will adhere to drill bit 513 and/or be drawn into the aperture and provide lubrication during drilling. Additionally, it is believed if the inorganic solid lubricant 522 has a high thermal conductivity (as discussed above), the temperature of the drill 513 can be reduced when it drills through layer 520 by thermal conduction.

The layer 520 can comprise one or more of the solid lubricant materials discussed above. In one nonlimiting embodiment of the present invention, layer 520 preferably comprises hexagonal boron nitride. Layer 520 can further comprise other materials, such as polymers and waxes if desired. In another nonlimiting embodiment of the present invention, layer 520 comprises at least one binding material to bind together the individual particles of the solid lubricant material 522. However, solid lubricant materials 522 that have been compacted together without the use of a binding material to form layer 520 can also be used in accordance with the present invention. Nonlimiting examples of binding materials believed to be useful in the present invention include, polymers, such as polyvinyl alcohol, polyvinylpyrrolidone; polyurethane, polyvinyl acetate, polyacrylates, polyesters, fatty acid esters, polyethers, polyglycidal methacrylate; and waxes, such as paraffin. In addition to the binding materials and the inorganic solid lubricants, the layer 520 can comprise organic lubricant materials, such as, for example, zinc stearate, polytetrafluoroethylene, paraffin wax, fatty acids, fatty acid esters, and polyethylene glycol.

Layer 520 can have any thickness 526 necessary to provide the desired drilling characteristics. In one nonlimiting embodiment, the layer 520 is made to be as thin as possible while providing the needed drilling and handling characteristics.

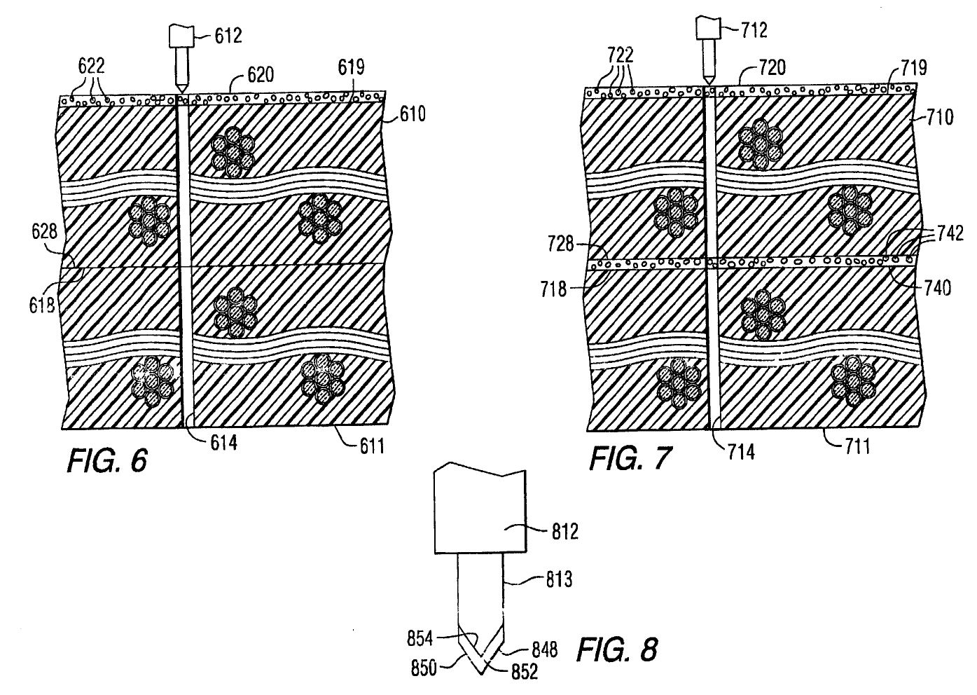

It is contemplated that multiple electronic supports can be stacked and drilled in a single aperture forming operation using the teachings of the present invention. More particularly and referring to FIG. 6, in one nonlimiting embodiment of the present invention, a first electronic support 610 and a second electronic support 611 can be stacked one on top of the other, such that a lower surface 628 of the first electronic support 610 is adjacent to the upper surface 618 of the second electronic support 611. A layer 620 comprising an inorganic solid lubricant 622 is positioned adjacent upper surface 619 of the first electronic support 610 prior to forming an aperture 614 in the electronic supports 610, 611 with an aperture forming device 612. It will be recognized by one skilled in the art that although 610 and 611 are depicted as single layer electronic supports in FIG. 6, they can be any type of electronic support known in the art, including but not limited to, multilayer laminates and printed circuit boards.

It is further contemplated that the lubricating layer can be positioned between selected adjacent electronic supports during the aperture forming operation. More specifically and as shown in FIG. 7, a layer 740 comprising an inorganic solid lubricant 742 can be positioned between the lower surface 728 of a first electronic support 710 and the upper surface 718 of a second electronic support 711 prior to aperture formation. It is also contemplated that multiple lubricating layers can be used in the aperture forming operation. For example and as discussed earlier, FIG. 5 shows an electronic support 510 with two lubricating layers 520 and 530 positioned along opposing major surfaces 518 and 528, respectively, of the electronic support 510. In another nonlimiting embodiment of the invention as shown in FIG. 7, where there are multiple electronic supports 710, 711, a layer 740 comprising an inorganic solid lubricant 742 is positioned between first electronic support 710 and second electronic support 711, and optionally another layer 720 comprising an inorganic solid lubricant 722 can be positioned adjacent upper surface 719 of electronic support 710 prior forming an aperture 714 in the electronic supports 710, 711 with an aperture forming device 712.

In one nonlimiting embodiment of the invention, a plurality of electronic supports are stacked together and a layer comprising an inorganic solid lubricant is positioned between each adjacent electronic support of the plurality of electronic supports. Additionally, if desired a lubricating layer can be positioned adjacent either or both of the exposed opposing major surfaces of the stacked electronic supports.

In another nonlimiting embodiment of a method of forming an aperture in an electronic support according to the present invention, at least one electronic support is located in registry with an aperture forming device such that an upper surface of the at least one electronic support is adjacent to the aperture forming device. A layer comprising hexagonal boron nitride is positioned between the upper surface of the at least one electronic support and the aperture forming device, and an aperture is formed at least partially through a thickness of the at least one electronic support with the aperture forming device.

It will be appreciated by one skilled in the art that, in any of the methods of forming an aperture described above, the layer comprising the inorganic solid lubricant can be positioned along at least a portion of the electronic support(s) to be drilled prior to locating the electronic support(s) in registry with the aperture forming device.

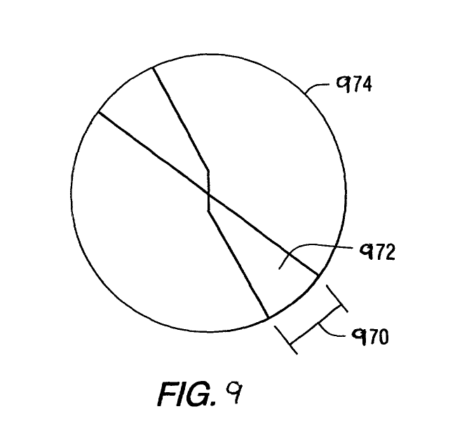

In another nonlimiting embodiment of the present invention, a solid lubricant material can be incorporated into the aperture forming device. More specifically and referring to FIG. 8, aperture forming device 812 comprises a drill bit 813 having external surfaces 848 and a coating material 850 comprising a lamellar solid lubricant 852 positioned upon at least a portion 854 of the external surfaces 848. In one nonlimiting embodiment of the present invention, the lubricant 853 is hexagonal boron nitride. Although not limiting in the present invention, in one embodiment the coating material 850 is positioned upon at least a portion of external cutting surfaces of drill bit 813.

The coating material 850 positioned on at least a portion 854 of the external surfaces 848 of the drill bit 813 can be applied by any method known in the art for applying such coatings. For example, the coating 850, and in particular a coating comprising hexagonal boron nitride, can be applied by spraying, painting, sputtering, CVD (chemical vapor deposition), plasma deposition or pulsed laser deposition. Alternatively, the coating comprising a solid lubricant 852 can be formed by chemical methods. For example and without limiting the present invention, in applying a coating comprising hexagonal boron nitride, a reaction product formed by reacting boric acid and melamine can be applied to the external surfaces of the drill bit and the drill bit exposed to a temperature greater than 800° C. for 60 minutes to form the hexagonal boron nitride layer.

In another nonlimiting example of an alternative method of forming an aperture forming device 812 according to the present invention, an inorganic solid lubricant 852, such as but not limited to powdered, hexagonal boron nitride, can be combined with one or more powdered metals and/or carbides, and sintering aids and a drill bit 813 formed therefrom via powder metallurgical techniques that are well known in the art. For more information, see “Cemented Carbide with Self-Lubricant Boron Nitride”, Japanese New Materials High-Performance Ceramic, Newmedia International, Japan, Sep. 2, 1991.

It will be appreciated by one skilled in the art that the aperture forming device 812 described above can be used in conjunction with any of the methods of forming apertures in an electronic support discussed above, or it can be used in conventional aperture forming processes. More specifically, when using an aperture forming device 812 to form an aperture in an electronic support, (1) the electronic support is located in registry with an aperture forming device comprising a drill bit having external surfaces at least partially coated with a coating material comprising hexagonal boron nitride; (2) the aperture forming device is brought into contact with at least a portion of a first side of the electronic support; and (3) an aperture extending at least partially through the electronic support is formed by penetrating at least the first side of the electronic support.

The present invention further contemplates electronic supports and printed circuit boards made using the aperture forming methods discussed in detail above.

Nonlimiting embodiments of the present invention will now be described in the following examples.

### EXAMPLES

A series of electrical grade prepregs and laminates incorporating feature of the present invention were prepared as follows:

Laminate A:

A heat cleaned and silane finished electrical grade 7628 style E-glass fabric was impregnated and B-stage cured (i.e. partially cured) by Nelco International Corporation of Anaheim, Calif. using commercial prepregging equipment and techniques to form a prepreg. The impregnating resin was an FR-4 epoxy resin having a Tg of 140° C. and designated by Nelco as 4000-2 epoxy resin. Eight prepregs were stacked between the press plates of a laminating press, with 1 oz. copper foil placed on the top and bottom of the stack. The press plates of the laminating press were preheated to a temperature of 93° C. (200° F.) and the stack was pressed for 4 minutes at a pressure of 0.1 megaPascals (MPa) (16 psi). The temperature was then increased at a rate of 4.4° C. to 6.6° C. (8° F. to 12° F.) until the plate temperature reached 177° C. (350° F.). The laminating pressure was then increased to 2.3 MPa (350 psi) and held for 60 minutes. The temperature of the laminate was lowered first by circulating water through the press plates for 25 minutes and then circulating air through the press plates for 25 minutes while maintaining the laminating pressure throughout. Thereafter, the pressure was released and the laminate was removed from the laminating press. The laminate was then trimmed to form Laminate A. Glass content in each laminate ranged between 60 to 65 weight percent. The dimensions of Laminate A were 45.7 centimeters (cm) by 61.0 cm (18 in. by 24 in.).

Laminate B:

Laminate B was prepared in the same manner and with the same materials as Laminate A except that a layer of boron nitride was applied between each set of prepregs, i.e. the laminate included eight prepreg layers and seven boron nitride layers. More particularly, each boron nitride layer was applied manually by spraying a major surface of seven of the prepregs with Boron Nitride Aerosol Lubricant until visual inspection showed uniform coverage. Boron Nitride Aerosol Lubricant is commercially available from ZYP Coatings, Inc. of Oak Ridge, Tenn. and contains boron nitride, acetone, and a propellant. The total amount of boron nitride included in the seven layers varied from 50 to 70 grams. No boron nitride was applied to any surface of any prepreg that ended up as an outer major surface of the laminate. Because the spray coating was applied manually, the amount of boron nitride varied from layer to layer and from laminate to laminate. However, it is expected that each layer included in the range of 2.56 to 3.58 mg of boron nitride per square centimeter of pregreg. Glass content in each laminate ranged between 70 to 75 weight percent.

Laminate C:

A 50.8 cm by 68.6 cm (20 in. by 27 in.) 7628 style E-glass fabric was hand coated with 120 grams of Nelco 4000-2 FR-4 epoxy resin using a brush to apply and uniformly spread the resin solution over the fabric. The coated fabric was then B-stage cured in an air circulating oven at 154° C. (310° F.) for 3 to 5 minutes to form a prepreg. The fabric was a heat cleaned and silane finished electrical grade 7628 style fabric for epoxy resin commercially available from Bedford Weaving of Lynchburg, Va. Laminates were then formed by stacking and pressing eight prepregs and two copper foil layers in the same manner as described earlier for Laminate A. Glass content in each laminate ranged from 70 to 75 weight percent.

Laminate D:

Laminate D was prepared in the same manner and with the same materials as Laminate C except that the FR-4 epoxy resin included boron nitride particles. More particularly, 9 grams of POLARTHERM 160 hexagonal boron nitride powder (previously discussed) were mixed with 25 grams of acetone (commercially available from Fischer Scientific of Pittsburgh, PA) to wet the boron nitride and form a paste that was 26 weight percent boron nitride. The paste was then dispersed in 120 grams of Nelco 4000-02 epoxy resin to form an epoxy resin comprising 11 weight percent boron nitride on a total solids basis. Glass content in each laminate ranged from 70 to 75 weight percent.

Test 1

Laminates A, B and D were evaluated for thermal conductivity and thermal resistance in air at temperatures of 300K (70° F.) according to ASTM Method C-177, which is specifically incorporated by reference herein. For the particular Laminate B tested, the laminate included a total of 55 grams of boron nitride. The values for thermal conductivity measured for each laminate are set forth in Table 1 below.

TABLE 1

| | Laminate | | |
|---|---|---|---|
| | A | B | D |
| Thickness (measured during testing) | | | |
| inches | 0.057 | 0.057 | 0.044 |
| centimeters | 0.145 | 0.145 | 0.112 |
| Temperature | | | |
| ° F. | 75.5 | 74.6 | 74.7 |
| ° C. | 24.2 | 23.7 | 23.7 |
| Thermal conductivity | | | |
| Btu inches per hour square feet ° F. | 1.50 | 2.24 | 2.18 |
| Watts per meter K | 0.216 | 0.323 | 0.314 |

Referring to Table 1, the measured thermal conductivity of Laminates B and D, both of which incorporated boron nitride, was higher than the measured thermal conductivity of Laminate A. More particularly, the measured thermal conductivity of Laminate B, which incorporated features of the present invention, was 50% greater than that of Laminate A, and the measured thermal conductivity of Laminate D, which incorporated features of the present invention, was 45% greater than that of Laminate A.

Based on the above data, in one nonlimiting embodiment of the present invention, the thermal conductivity of an electronic support in the form of a laminate comprising a first prepreg layer; a second prepreg layer positioned adjacent a major surface of the first prepreg layer; and at least one layer comprising hexagonal boron nitride powder positioned between the first prepreg layer and the second prepreg layer, the at least one layer comprising no greater than 25 weight percent of adhesive materials based on the total weight of the at least one partial layer on a total solids basis, is at least 0.27 W/mK. In one nonlimiting embodiment, the thermal conductivity of the above electronic support is at least 0.29 W/mK. In another nonlimiting embodiment, the thermal conductivity of the above electronic support is at least 0.31 W/mK.

In another nonlimiting embodiment of the present invention, the thermal conductivity of an electronic support comprising a laminate comprising two or more prepreg layers, at least one of the two or more prepreg layers comprising (1) at least one woven, glass fiber reinforcement material formed from at least one fiber free of basalt glass; and (2) at least one matrix material in contact with at least a portion of the at least one reinforcement material, the at least one matrix material comprising (i) at least one non-fluorinated polymer, (ii) an epoxy resin, and (iii) at least one inorganic filler comprising hexagonal boron nitride powder, and wherein the at least one inorganic filler comprises at least 6 weight percent of a total combined weight of the at least one inorganic filler and the at least one matrix material on a total solids basis, is at least 0.27 W/mK. In another nonlimiting embodiment, the thermal conductivity of the above electronic support is at least 0.29 W/mK. In another nonlimiting embodiment, the thermal conductivity of the above electronic support is at least 0.31 W/mK.

Test 2

Laminates A, B, C and D were tested to evaluate the drill tip wear. Referring to FIG. 9, as used herein, the term “drill tip wear” means the reduction of the width 970 of the primary cutting edge 972 of the drill 974 as measured at the peripheral edge of the drill tip.

The drilling was performed on 3-high stacks of laminates with a 0.0105 inch (0.2667 mm) thick aluminum entry and 0.082 inch (2.083 mm) thick paper core phenolic coated back-up. Drilling three laminates at one time is generally standard practice in the industry. The drill tip wear was determined for a 0.018 inches (0.4572 mm) diameter drill. The drills were solid carbide micro-drills supplied by HAM of Schwendi-Horenhausen, Germany. The chip load during drilling was held constant at 0.00125 during drilling. As used herein, “chip load” means the ratio of the drill insertion rate measured in inches per minute to the spindle speed measured in revolutions per minute (rpm). The spindle speed was 100,000 rpm and the insertion rate was 125 inches (317.5 cm) per minutes. The retraction rate was 1000 inches (25.4 m) per minute. The drilling was done using a Pluritec single spindle, multi-station drilling machine available from Pluritec spa of Burolo, Italy.

Four stacks of three laminates for each laminate type were drilled. 1000 holes were drilled in the first stack of laminates for each laminate type with a single drill, 2000 holes were drilled in the second stack of laminates for each laminate type with a single drill, 3000 holes were drilled in the third stack of laminates for each laminate type with a single drill, and 4000 holes were drilled in the fourth stack of laminates for each laminate type with a single drill. Drill tip wear was measured after drilling each stack.

In order to compare the drill tip wear based on the total number of holes drilled and take into account both the total thickness drilled by each drill and the variations in laminate thickness, the drill wear coefficient for each drill was determined. As used herein, the terms “drill wear coefficient” and “ ” mean the amount of drill tip wear per distance drilled, and is calculated using the following formula:

$$= \frac{drill tip wear}{3 \times ( laminate thickness ) \times ( number of holes drilled )}$$

For example, if the drill tip wear was 6 m after drilling 3000 holes through a stack of 3 laminates each 1524 m (0.06 inches) thick, the drill wear coefficient would be 0.437 m/meter, i.e. 0.437 m of drill tip wear per meter of board thickness drilled. In addition, the drill wear coefficient for each set of drilled laminates was averaged to provide the average drill wear coefficient, ₐᵥₑ, based on 10,000 holes drilled as discussed above.

Table 2 shows and ₐᵥₑ for the four sets of laminates.

TABLE 2
Drill Wear Coefficient (μm/m)

| Lami- | Thickness | Number of Holes Drilled | | | | |
|---|---|---|---|---|---|---|
| nate | (mm) | 1000 | 2000 | 3000 | 4000 | ^{ave} |
| A | 1.4224-1.4986 | 0.6534 | 1.0785 | 0.5392 | 0.5786 | 0.7124 |
| B | 1.6256-1.6764 | 0.5628 | 0.5668 | 0.5314 | 0.5038 | 0.5412 |
| C | 1.1684-1.1938 | 0.6376 | 0.6770 | 0.5786 | 0.4920 | 0.5963 |
| D | 1.1938-1.2954 | 0.5943 | 0.5274 | 0.5038 | 0.4605 | 0.5215 |

When comparing Laminates A and B, both of which included commercially processed prepregs, the drill wear coefficient for the boron nitride containing Laminate B was less than that of non-boron nitride containing Laminate A. Similarly, when comparing Laminates C and D, both of which included prepregs prepared by hand, the drill wear coefficient for the boron nitride containing Laminate D was less than that of non-boron nitride containing Laminate C. These test results would indicate that the addition of boron nitride to the laminate, whether it be included in the epoxy resin or as a layer between the prepregs, tends to reduce drill tip wear.

It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

What is claimed is:

1. A method of forming an aperture in an electronic support, comprising:
A. positioning an electronic support in registry with an aperture forming device; and
B. forming an aperture at least partially through the electronic support with the aperture forming device while dispensing a fluid stream comprising at least one solid lubricant, proximate the aperture forming device during at least a position of the forming, such that the at least one solid lubricant contacts at least a portion of an interface between the aperture forming device and the electronic support.

2. The method according to claim 1, wherein the at least one solid lubricant is inorganic.

3. The method according to claim 2, wherein the at least one solid lubricant is selected from hexagonal boron nitride, boric acid, metal dichalcogenides, and graphite.

4. The method according to claim 3, wherein the at least one solid lubricant is hexagonal boron nitride.

5. The method according to claim 1, wherein the dispensing comprises impinging a fluid stream comprising at least one solid lubricant onto the aperture forming device.

6. The method according to claim 5, wherein the fluid stream comprises at least one carrier selected from liquid carriers and gaseous carriers.

7. The method according to claim 6, wherein the at least one solid lubricant is selected from inorganic lubricants, organic lubricants, and mixtures thereof.

8. The method according to claim 7, wherein the at least one solid lubricant is selected from hexagonal boron nitride, boric acid, metal dichalcogenides, and graphite.

9. The method according to claim 8, wherein the at least one solid lubricant is hexagonal boron nitride.

10. A method of forming an aperture in an electronic support, comprising:
A. locating an electronic support in registry with an aperture forming device such that a first surface of the electronic support is adjacent the aperture forming device;
B. positioning a single layer comprising at least one inorganic solid lubricant along at least a portion of the first surface of the electronic support; and
C. forming an aperture through the layer and at least partially through the electronic support with the aperture forming device.

11. The method according to claim 10, wherein the positioning step occurs before the locating step.

12. A method of forming an aperture in an electronic support, comprising:
A. locating at least one electronic support in registry with an aperture forming device such that a first surface of the electronic support is adjacent the aperture forming device;
B. positioning a layer comprising at least one inorganic solid lubricant in direct contact with at least a portion of the first surface of the electronic support; and
C. forming an aperture through the layer and at least partially through the at least one electronic support with the aperture forming device.

13. The method according to claim 12, wherein the at least one electronic support is a first electronic support, and wherein the method further comprises positioning a second electronic support adjacent to an opposing surface of the first electronic support, and wherein forming comprises forming an aperture extending through at least a portion of the second electronic support.

14. The method according to claim 12, wherein the layer is a first layer and further comprising positioning a second layer comprising at least one inorganic solid lubricant between the first and second electronic supports, and wherein forming comprises forming an aperture through the second layer.

15. The method according to claim 12, wherein the at least one electronic support is a stack of electronic supports, and wherein forming comprises forming an aperture through at least a portion of each electronic support of the stack of electronic supports.

16. The method according to claim 15, further comprising positioning a layer comprising at least one inorganic solid lubricant between selected adjacent electronic supports of the stack of electronic supports.

17. The method according to claim 12, wherein the layer is a first layer, and further comprising positioning a second layer comprising at least one inorganic solid lubricant along at least a portion of an opposing surface of the at least one electronic support.

18. The method according to claim 12, wherein the at least one inorganic solid lubricant is selected from hexagonal boron nitride, boric acid, metal dichalcogenides, and graphite.

19. The method according to claim 18, wherein the at least one inorganic solid lubricant is hexagonal boron nitride.

20. The method according to claim 12, wherein the layer is a single layer.

21. A method of forming an aperture in an electronic support, comprising:
A. locating an electronic support in registry with an aperture forming device such that a first surface of the electronic support is adjacent the aperture forming device;
B. positioning at least one layer comprising hexagonal boron nitride along a least a portion of the first surface of the electronic support; and
C. forming an aperture through the at least one layer and at least partially through the electronic support with the aperture forming device.

22. An aperture forming device for use in forming apertures in electronic supports, comprising:
A. a drill bit external surfaces; and
B. a coating material positioned upon at least a portion of the external surfaces of the drill bit, the coating material comprising at least one solid lubricant.

23. The aperture forming device according to claim 22, wherein the at least a portion of the external surfaces is a cutting surface.

24. The aperture forming device according to claim 22, wherein at least one solid lubricant is an inorganic lubricant.

25. The aperture forming device according to claim 24, wherein the at least one inorganic solid lubricant is selected from hexagonal boron nitride, boric acid, metal dichalcogenides, and graphite.

26. The aperture forming device according to claim 25, wherein the at least one inorganic solid lubricant is hexagonal boron nitride.

27. A method of forming an aperture in an electronic support, comprising:
A. locating an electronic support in registry with an aperture forming device, the aperture forming device comprising:
1. a drill bit having external surfaces; and
2. a coating material positioned upon at least a portion of the external surfaces of the drill bit, the coating material comprising at least one lamellar solid lubricant; and
B. penetrating at least a first side of the electronic support with the drill bit to form an aperture extending at least partially through the electronic support.

28. The method according to claim 27, wherein the at least one solid lubricant is selected from hexagonal boron nitride, boric acid, metal dichalcogenides, and graphite.

29. The method according to claim 28, wherein the at least one solid lubricant is hexagonal boron nitride.

30. A method of forming an aperture in an electronic support, comprising:
A. locating an electronic support in registry with an aperture forming device such that a first surface of the electronic support is adjacent a drill bit of the aperture forming device, the drill bit comprising:
1. a channel extending at least partially through an interior portion of the drill bit, and
2. at least one hole extending from an external surface of the drill bit into the channel;
B. forming an aperture at least partially through the electronic support with the drill bit of the aperture forming device; and
C. passing at least one solid lubricant through the channel of the drill bit and out the at least one hole during at least a portion of the forming to provide lubrication.

31. The method according to claim 30, wherein the at least one inorganic solid lubricant is hexagonal boron nitride.

32. A method of forming an aperture in an electronic support, comprising:
A. locating an electronic support in registry with an aperture forming device such that a first surface of the electronic support is adjacent the aperture forming device, the electronic support comprising at least one internal lubricant layer; and
B. forming an aperture through the at least one internal lubricant layer and at least partially through the electronic support with the aperture forming device.

33. The method according to claim 32, wherein the at least one internal lubricant layer comprises hexagonal boron nitride.

34. A printed circuit board comprising at least one aperture extending at least partially through the printed circuit board, wherein the aperture is formed by:
A. locating an electronic support in registry with an aperture forming device; and
B. forming an aperture at least partially through the electronic support with the aperture forming device while dispensing a fluid stream comprising at least one solid lubricant proximate the aperture forming device during at least a portion of the forming, such that the at least one solid lubricant contacts at least a portion of an interface between the aperture forming device and the electronic support.

35. The printed circuit board according to claim 34, wherein the at least one solid lubricant is hexagonal boron nitride.

36. A printed circuit board comprising at least one aperture extending at least partially through the printed circuit board, wherein the aperture is formed by:
A. locating an electronic support in registry with an aperture forming device such that a first surface of the electronic support is adjacent the aperture forming device;
B. positioning a layer comprising at least one inorganic solid lubricant along at least a portion of the first surface of the electronic support; and
C. forming an aperture through the layer and at least partially through the electronic support with the aperture forming device.

37. The printed circuit board according to claim 36, wherein the at least one inorganic solid lubricant is hexagonal boron nitride.

38. A printed circuit board comprising at least one aperture extending at least partially through the printed circuit board, wherein the aperture is formed by:
A. positioning an electronic support in registry with an aperture forming device, the aperture forming device comprising:
1. a drill bit having external surfaces; and
2. a coating material positioned upon at least a portion of the external surfaces of the drill bit, the coating material comprising at least one lamellar solid lubricant; and
B. penetrating the first side of the printed circuit board with the drill bit to form an aperture extending at least partially through the electronic support.

39. The printed circuit board according to claim 38, wherein the at least one solid lubricant is hexagonal boron nitride.

40. The printed circuit board according to claim 39, wherein the hexagonal boron nitride is a reaction product formed by reacting of boric acid and a melamine.
